(19) United States
(12) Patent Application Publication
(10) Pub. No.: US 2025/0227269 A1
(43) Pub. Date: Jul. 10, 2025

(54) SIGNAL PROCESSING WITH OVERLAY REGIONS

(71) Applicant: V-NOVA INTERNATIONAL LIMITED, London (GB)

(72) Inventors: Simone FERRARA, London (GB); Guido MEARDI, London (GB)

(21) Appl. No.: 18/852,708

(22) PCT Filed: Feb. 24, 2023
(86) PCT No.: PCT/GB2023/050425

§ 371 Date: Sep. 30, 2024

(30) Foreign Application Priority Data
Mar. 31, 2022 (GB) 2204655.1

(51) Int. Cl. H04N 19/30; G06T 3/4053; G06T 5/92; H04N 19/167; H04N 19/17

(52) U.S. Cl. CPC H04N 19/30; G06T 3/4053; G06T 5/92; H04N 19/167; H04N 19/17; G06T 2207/10016; G06T 2207/20208

(57) ABSTRACT

A first signal (801) is processed by at least sending the first signal (801) to an encoder (804) to generate an encoded signal (805). A second signal (808) is obtained. The second signal (808) comprises an overlay region (810). The overlay region (810) of the second signal (808) comprises overlay content. At least the second signal (808) is processed to generate residual data (815). The residual data (815) is encoded to generate encoded residual data. At least the encoded residual data is output.

### TECHNICAL FIELD

The present invention relates to methods for processing signals, such as by way of non-limiting examples video, image, hyperspectral image, audio, point clouds, 3DoF/6DoF and volumetric signals. Processing data may include, but is not limited to, obtaining, deriving, encoding, outputting, receiving and reconstructing a signal in the context of a hierarchical (tier-based) coding format, where the signal is decoded in tiers at subsequently higher level of quality, leveraging and combining subsequent tiers (“echelons”) of reconstruction data. Different tiers of the signal may be coded with different coding formats (e.g., by way of non-limiting examples, traditional single-layer DCT-based codecs, ISO/IEC MPEG-5 Part 2 Low Complexity Enhancement Video Coding SMPTE VC-6 2117, etc.), by means of different elementary streams that may or may not multiplexed in a single bitstream.

### BACKGROUND

A hybrid backward-compatible coding technology has been previously proposed, for example in WO 2014/170819 and WO 2018/046940, the contents of which are incorporated herein by reference.

Processing residuals in video coding has previously been proposed, for example in WO 2020/188229, the contents of which are incorporated herein by reference.

The contents of WO 2020/074896, WO 2020/074897, WO 2020/089583, and WO 2020/074898 are also incorporated herein by reference.

A low complexity enhancement video coding system has previously been described, for example in WO 2020/188273 and in ISO/IEC 23094-2 (first published draft in January 2020), known as the “LCEVC standard” or “LCEVC”, the contents of which are incorporated herein by reference.

Technological progress means that there are many different techniques and methods for processing signals, especially for compression, storage and transmission. For example, over the years, many ways to encode picture and video signals so that the information is compressed have been developed. This has benefits of reducing the storage requirements and bandwidth requirements of any transmission path, either via over-the-air terrestrial broadcasts, cable broadcasts, satellite broadcasts, or via the Internet or other data networks. As technology advances, more sophisticated methods of compression and transmission have been developed. Increased quality signals are desired. For example signals having increased video resolution (manifesting as increased pixels per frame or increased frames per second) are in demand. As a result, there are many signal formats in existence, and many types of signal encoders and decoders that may or may not be able to use those formats. This creates a problem for content creators and distributors, as they wish to ensure their content is available to the widest audiences. As a result, the creators and distributors have to provide their content in many different encoding formats, for example, encoded using standard encoding techniques such as MPEG-2, MPEG-4 Part 10, High Efficiency Video Coding (HEVC), etc. In addition, the distribution of the encoded signals is also facilitated by standard and non-standard broadcasting and streaming techniques. All in all, this makes for a complex situation increasing the costs for content distributors, and it makes the adoption of newer and better technologies more difficult owing to the lack of compatibility of older technologies (e.g. such as legacy decoders and set-top boxes) which remain widespread.

High Dynamic Range (HDR) video has demonstrated the potential to transmit much higher quality video by adding one dimension of quality improvements, that is, aside from increasing resolution (i.e., more pixels per frame) and increasing motion fidelity (i.e., more frames per second), operators can also increase dynamic range (i.e., greater range of luminance, and more tones, and thus more vivid contrasts and colours). Broad availability of HDR-capable displays is making HDR video increasingly relevant.

HDR typically refers to a higher luminance and/or colour range than Standard Dynamic Range (SDR), the latter using a conventional gamma curve to represent a range of colours. HDR typically works by changing the value of the brightest and the darkest colours, as well as by using a different colour plane (typically extended from the standard colour plane to a wider colour gamut plane).

There are various HDR implementations currently on the market, typically requiring a 10-bit (or even higher bit-depth) representation of colour components (e.g. luma Y and chroma Cb and Cr), in order to have a sufficiently large range of available values. One such HDR implementation is HDR10, which uses static metadata in a video signal to adjust the range of luminance and colours represented in a video stream. In this way, a single HDR setting is applied throughout the video sequence. Different implementations using dynamic metadata go under various commercial names, such as HDR10+ or Dolby® Vision. With dynamic metadata, the HDR settings are changed on a frame-by-frame basis, thus allowing greater granularity and adaptation to change of scenes.

However, transmission of HDR video currently requires decoders able to decode native 10-bit video formats, such as HEVC. This often requires duplication of video workflows, since most operators need to continue serving the large portion of their customer base that only possesses legacy devices able to decode 8-bit AVC/H.264 video. Similarly, it also prevents operators from using HDR with 8-bit formats such as VP9. In addition, the tone mapping required by HDR is not necessarily a best fit to optimize compression efficiency. For further information on this aspect, we refer to the following paper: A. Banitalebi-Dehkordi, M. Azimi, M. T. Pourazad and P. Nasiopoulos, “Compression of high dynamic range video using the HEVC and H.264/AVC standards,” 10th International Conference on Heterogeneous Networking for Quality, Reliability, Security and Robustness, Rhodes, 2014, pp. 8-12.

There is a general problem with the incompatibility of newer coding standards, and in particular HDR-related standards or techniques, with legacy decoding equipment that cannot easily be replaced or upgraded. There is also a general problem of limited bandwidth availability for transmitting signals. There is also a general problem of the processing and storage overhead for content distributers in creating and maintaining many versions of the same content encoded in different ways. This problem is exacerbated by the introduction of several competing and broadly incompatible techniques of encoding HDR-type signals (i.e. those signals having the potential for greater luminance ranges and contrast ratios and/or those signals containing information representative of a wider colour gamut).

There is a further need to encode ‘hybrid’ images having portions of content that are HDR and portions of content that are SDR. Such aforementioned problems hinder the implementation of such arrangements, such as attempting to encode a single image having portions that are SDR and portions that are HDR. For example, the above problems contribute to the overall problem of how to efficiently encode an image comprising HDR content (e.g. an image) overlaid onto a SDR image. Equivalently, the above problems contribute to the overall problem of how to efficiently encode an image comprising SDR image overlaid with HDR content.

More generally, there are currently problems with efficiently encoding hybrid images, videos and other signals having different types of content, of which hybrid signals with SDR and HDR content are an example.

### SUMMARY

Aspects and variations of the present invention are set out in the appended claims.

Certain unclaimed aspects are further set out in the detailed description below. Further features and advantages will become apparent from the following description, given by way of example only, which is made with reference to the accompanying drawings.

### BRIEF DESCRIPTION OF THE DRAWINGS

FIG. 1 shows a high-level schematic of an example hierarchical encoding and decoding process;

FIG. 2 shows a high-level schematic of an example hierarchical deconstruction process;

FIG. 3 shows an alternative high-level schematic of an example hierarchical deconstruction process;

FIG. 4 shows a high-level schematic of an example encoding process suitable for encoding the residuals of tiered outputs;

FIG. 5 shows a high-level schematic of an example hierarchical decoding process suitable for decoding each output level from FIG. 4;

FIG. 6 shows a high-level schematic of an example encoding process of a hierarchical coding technology;

FIG. 7 shows a high-level schematic of an example decoding process suitable for decoding the output of FIG. 6;

FIG. 8 shows a high-level schematic of another example encoding process of a hierarchical coding technology;

FIG. 9 shows a high-level schematic of another example encoding process of a hierarchical coding technology;

FIG. 10 shows a high-level schematic of another example encoding process of a hierarchical coding technology;

FIG. 11 shows a high-level schematic of another example encoding process of a hierarchical coding technology;

FIG. 12 shows a high-level schematic of another example encoding process of a hierarchical coding technology;

FIG. 13 shows a high-level schematic of another example encoding process of a hierarchical coding technology;

FIG. 14 shows a high-level schematic of another example encoding process of a hierarchical coding technology; and

FIG. 15 shows a block diagram of an example of an apparatus in accordance with embodiments.

### DETAILED DESCRIPTION

Certain examples described herein relate to methods for encoding and decoding signals. Processing data may include, but is not limited to, obtaining, deriving, outputting, receiving and reconstructing data. The present examples relate to the control of signal processing operations that are performed at an encoder and/or at a decoder. These may comprise optional signal processing operations to provide an enhanced output signal. For video signals, the enhanced output signal may comprise a so-called “super-resolution” signal, e.g. a signal with improved detail resolution as compared to a reference signal. The reference signal may comprise an encoding of a video sequence at a first resolution and the enhanced output signal may comprise a decoded version of the video sequence at a second resolution, which is higher than the first resolution. The first resolution may comprise a native resolution for the video sequence, e.g. a resolution at which the video sequence is obtained for encoding.

### Introduction

Examples described herein relate to signal processing. A signal may be considered as a sequence of samples (i.e., two-dimensional images, video frames, video fields, sound frames, etc.). In the description, the terms “image”, “picture” or “plane” (intended with the broadest meaning of “hyperplane”, i.e., array of elements with any number of dimensions and a given sampling grid) will be often used to identify the digital rendition of a sample of the signal along the sequence of samples, wherein each plane has a given resolution for each of its dimensions (e.g., X and Y), and comprises a set of plane elements (or “signal element”, “element”, or “pel”, or display element for two-dimensional images often called “pixel”, for volumetric images often called “voxel”, etc.) characterized by one or more “signal element values”, “element values”, “values” or “settings” (e.g., by ways of non-limiting examples, colour settings in a suitable colour space, settings indicating density levels, settings indicating temperature levels, settings indicating audio pitch, settings indicating amplitude, settings indicating depth, settings indicating alpha channel transparency level, etc.). Each plane element is identified by a suitable set of coordinates, indicating the integer positions of said element in the sampling grid of the image. Signal dimensions can include only spatial dimensions (e.g., in the case of an image) or also a time dimension (e.g., in the case of a signal evolving over time, such as a video signal).

As examples, a signal can be an image, an audio signal, a multi-channel audio signal, a telemetry signal, a video signal, a 3DoF/6DoF video signal, a volumetric signal (e.g., medical imaging, scientific imaging, holographic imaging, etc.), a volumetric video signal, or even signals with more than four dimensions.

For simplicity, examples described herein often refer to signals that are displayed as 2D planes of settings (e.g., 2D images in a suitable colour space), such as for instance a video signal. The terms “frame” or “field” will be used interchangeably with the term “image”, so as to indicate a sample in time of the video signal. Any concepts and methods illustrated for video signals made of frames (progressive video signals) can be easily applicable also to video signals made of fields (interlaced video signals), and vice versa. Despite the focus of embodiments illustrated herein on image and video signals, people skilled in the art can easily understand that the same concepts and methods are also applicable to any other types of multidimensional signal (e.g., audio signals, volumetric signals, stereoscopic video signals, 3DoF/6DoF video signals, plenoptic signals, point clouds, etc.).

Certain tier-based hierarchical formats described herein use a varying amount of correction (e.g., in the form of also “residual data”, or simply “residuals”) in order to generate a reconstruction of the signal at the given level of quality that best resembles (or even losslessly reconstructs) the original. The amount of correction may be based on a fidelity of a predicted rendition of a given level of quality.

In order to achieve a high-fidelity reconstruction, coding methods may upsample a lower resolution reconstruction of the signal to the next higher resolution reconstruction of the signal. In certain case, different signals may be best processed with different methods, i.e., a same method may not be optimal for all signals.

In addition, it has been determined that non-linear methods may be more effective than more conventional linear kernels (especially separable ones), but at the cost of increased processing power requirements. For the most part, due to processing power limitations, so far linear upsampling kernels of various sizes have been used (e.g., bilinear, bicubic, multi-lobe Lanczos, etc.), but more recently even more sophisticated non-linear techniques, such as the use of convolutional neural networks in VC-6, have been shown to produce higher quality preliminary reconstructions, thus reducing the entropy of residual data to be added for a high-fidelity final reconstruction.

In formats such as LCEVC, it is possible to signal to the decoder the coefficients of the upsampling kernel to be used before LCEVC's non-linear addition of “predicted residuals”. At the same time, it is proposed to extend capabilities of the coding standard to embed in the coded stream reconstruction metadata that is ignored by unaware decoder, but that is processed by decoders that are capable to decode said user data.

### Examples of a Tier-Based Hierarchical Coding Scheme or Format

In preferred examples, the encoders or decoders are part of a tier-based hierarchical coding scheme or format. Examples of a tier-based hierarchical coding scheme include LCEVC: MPEG-5 Part 2 LCEVC (“Low Complexity Enhancement Video Coding”) and VC-6: SMPTE VC-6 ST-2117, the former being described in PCT/GB2020/050695, published as WO 2020/188273, (and the associated standard document) and the latter being described in PCT/GB2018/053552, published as WO 2019/111010, (and the associated standard document), all of which are incorporated by reference herein. However, the concepts illustrated herein need not be limited to these specific hierarchical coding schemes.

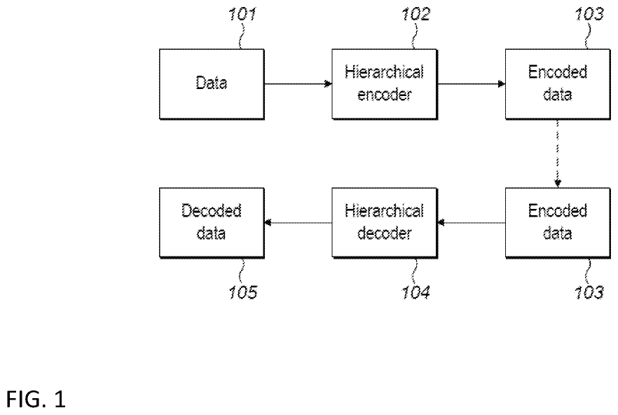

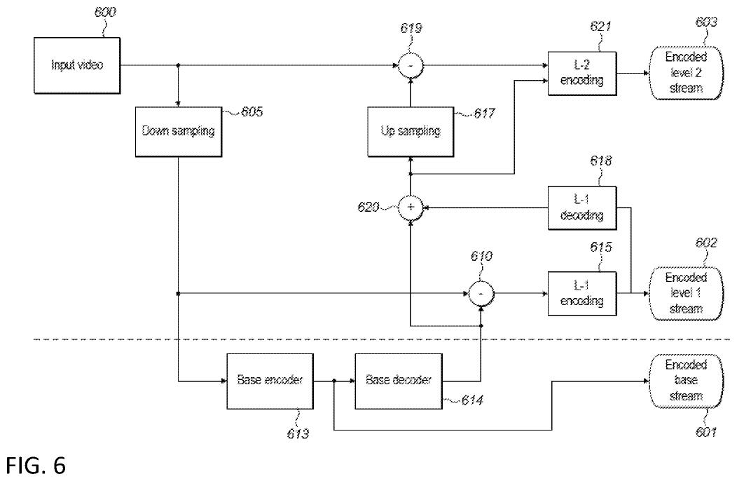

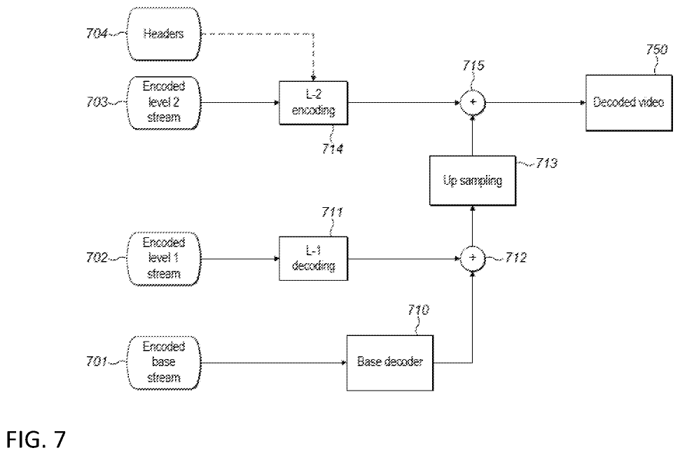

FIGS. 1 to 7 provide an overview of different example tier-based hierarchical coding formats. These are provided as context for the addition of further signal processing operations, which are set out in the Figures following FIG. 7. FIGS. 1 to 5 provide examples similar to the implementation of SMPTE VC-6 ST-2117, whereas FIGS. 6 and 7 provide examples similar to the implementation of MPEG-5 Part 2 LCEVC. It may be seen that both sets of examples utilise common underlying operations (e.g., downsampling, upsampling and residual generation) and may share modular implementing technologies.

FIG. 1 illustrates, very generally, a hierarchical coding scheme. Data to be encoded 101 is retrieved by a hierarchical encoder 102 which outputs encoded data 103. Subsequently, the encoded data 103 is received by a hierarchical decoder 104 which decodes the data and outputs decoded data 105.

Typically, the hierarchical coding schemes used in examples herein create a base or core level, which is a representation of the original data at a lower level of quality and one or more levels of residuals which can be used to recreate the original data at a higher level of quality using a decoded version of the base level data. In general, the term “residuals” as used herein refers to a difference between a value of a reference array or reference frame and an actual array or frame of data. The array may be a one or two-dimensional array that represents a coding unit. For example, a coding unit may be a 2×2 or 4×4 set of residual values that correspond to similar sized areas of an input video frame.

It should be noted that the generalised examples are agnostic as to the nature of the input signal. Reference to “residual data” as used herein refers to data derived from a set of residuals, e.g. a set of residuals themselves or an output of a set of data processing operations that are performed on the set of residuals. Throughout the present description, generally a set of residuals includes a plurality of residuals or residual elements, each residual or residual element corresponding to a signal element, that is, an element of the signal or original data.

In specific examples, the data may be an image or video. In these examples, the set of residuals corresponds to an image or frame of the video, with each residual being associated with a pixel of the signal, the pixel being the signal element.

The methods described herein may be applied to so-called planes of data that reflect different colour components of a video signal. For example, the methods may be applied to different planes of YUV or RGB data reflecting different colour channels. Different colour channels may be processed in parallel. The components of each stream may be collated in any logical order.

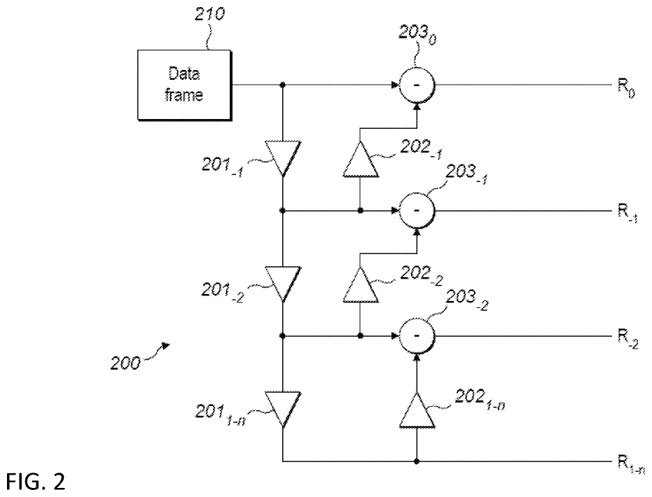

A hierarchical coding scheme will now be described in which the concepts of the invention may be deployed. The scheme is conceptually illustrated in FIGS. 2 to 5 and corresponds generally to VC-6 described above. In such encoding techniques, residuals data is used in progressively higher levels of quality. In this proposed technique, a core layer represents the image at a first resolution and subsequent layers in the tiered hierarchy are residual data or adjustment layers necessary for the decoding side to reconstruct the image at a higher resolution. Each layer or level may be referred to as an echelon index, such that the residuals data is data required to correct low quality information present in a lower echelon index. Each layer or echelon index in this hierarchical technique, particularly each residual layer, is often a comparatively sparse data set having many zero value elements. When reference is made to an echelon index, it refers collectively to all echelons or sets of components at that level, for example, all subsets arising from a transform step performed at that level of quality.

In this particular hierarchical manner, the described data structure removes any requirement for, or dependency on, the preceding or proceeding level of quality. A level of quality may be encoded and decoded separately, and without reference to any other layer. Thus, in contrast to many known other hierarchical encoding schemes, where there is a requirement to decode the lowest level of quality in order to decode any higher levels of quality, the described methodology does not require the decoding of any other layer. Nevertheless, the principles of exchanging information described below may also be applicable to other hierarchical coding schemes.

As shown in FIG. 2, the encoded data represents a set of layers or levels, generally referred to here as echelon indices. The base or core level represents the original data frame 210, albeit at the lowest level of quality or resolution and the subsequent residuals data echelons can combine with the data at the core echelon index to recreate the original image at progressively higher resolutions.

To create the core-echelon index, an input data frame 210 may be down-sampled using a number of down-sampling operations 201 corresponding to the number of levels or echelon indices to be used in the hierarchical coding operation. One fewer down-sampling operation 201 is required than the number of levels in the hierarchy. In all examples illustrated herein, there are 4 levels or echelon indices of output encoded data and accordingly 3 down-sampling operations, but it will of course be understood that these are merely for illustration. Where n indicates the number of levels, the number of down-samplers is n-1. The core level R₁₋ₙ is the output of the third down-sampling operation. As indicated above, the core level R₁₋ₙ corresponds to a representation of the input data frame at a lowest level of quality.

To distinguish between down-sampling operations 201, each will be referred to in the order in which the operation is performed on the input data 210 or by the data which its output represents. For example, the third down-sampling operation 201₁₋ₙ in the example may also be referred to as the core down-sampler as its output generates the core-echelon index or echelon₁₋ₙ, that is, the index of all echelons at this level is 1-n. Thus, in this example, the first down-sampling operation 201₋₁ corresponds to the R₋₁ down-sampler, the second down-sampling operation 201₋₂ corresponds to the R₋₂ down-sampler and the third down-sampling operation 201₁₋ₙ corresponds to the core or R₋₃ down-sampler.

As shown in FIG. 2, the data representing the core level of quality R₁₋ₙ undergoes an up-sampling operation 202₁₋ₙ, referred to here as the core up-sampler. A difference 203₋₂ between the output of the second down-sampling operation 201₋₂ (the output of the R₋₂ down-sampler, i.e. the input to the core down-sampler) and the output of the core up-sampler 202₁₋ₙ is output as the first residuals data R₋₂. This first residuals data R₋₂ is accordingly representative of the error between the core level R₋₃ and the signal that was used to create that level. Since that signal has itself undergone two down-sampling operations in this example, the first residuals data R₋₂ is an adjustment layer which can be used to recreate the original signal at a higher level of quality than the core level of quality but a lower level than the input data frame 210.

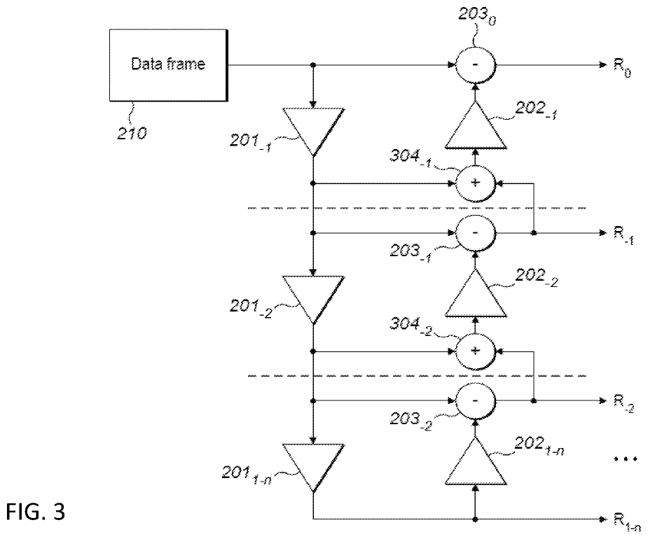

Variations in how to create residuals data representing higher levels of quality are conceptually illustrated in FIGS. 2 and 3.

In FIG. 2, the output of the second down-sampling operation 201₋₂ (or R₋₂ down-sampler, i.e. the signal used to create the first residuals data R₋₂), is up-sampled 202₋₂ and the difference 203₋₁ between the input to the second down-sampling operation 201₋₂ (or R₋₂ down-sampler, i.e. the output of the R₋₁ down-sampler) is calculated in much the same way as the first residuals data R₋₂ is created. This difference is accordingly the second residuals data R₋₁ and represents an adjustment layer which can be used to recreate the original signal at a higher level of quality using the data from the lower layers.

In the variation of FIG. 3, however, the output of the second down-sampling operation 201₋₂ (or R₋₂ down-sampler) is combined or summed 304₋₂ with the first residuals data R₋₂ to recreate the output of the core up-sampler 202₁₋ₙ. In this variation it is this recreated data which is up-sampled 202₋₂ rather than the down-sampled data. The up-sampled data is similarly compared 203₋₁ to the input to the second down-sampling operation (or R₋₂ down-sampler, i.e. the output of the R₋₁ down-sampler) to create the second residuals data R₋₁.

The variation between the implementations of FIGS. 2 and 3 results in slight variations in the residuals data between the two implementations. FIG. 2 benefits from greater potential for parallelisation.

The process or cycle repeats to create the third residuals R₀. In the examples of FIGS. 2 and 3, the output residuals data R₀ (i.e. the third residuals data) corresponds to the highest level and is used at the decoder to recreate the input data frame. At this level the difference operation is based on the input data frame which is the same as the input to the first down-sampling operation.

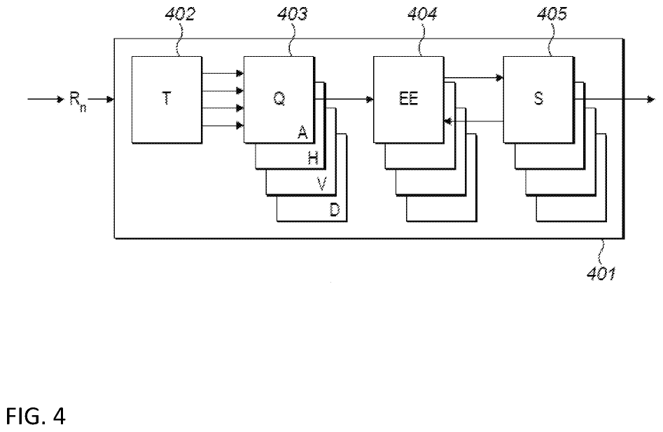

FIG. 4 illustrates an example encoding process 401 for encoding each of the levels or echelon indices of data to produce a set of encoded echelons of data having an echelon index. This encoding process is used merely for example of a suitable encoding process for encoding each of the levels, but it will be understood that any suitable encoding process may be used. The input to the process is a respective level of residuals data output from FIG. 2 or 3 and the output is a set of echelons of encoded residuals data, the echelons of encoded residuals data together hierarchically represent the encoded data.

In a first step, a transform 402 is performed. The transform may be directional decomposition transform as described in WO 2013/171173 or a wavelet or discrete cosine transform. If a directional decomposition transform is used, there may be output a set of four components (also referred to as transformed coefficients). When reference is made to an echelon index, it refers collectively to all directions (A, H, V, D), i.e., 4 echelons. The component set is then quantized 403 before entropy encoding. In this example, the entropy encoding operation 404 is coupled to a sparsification step 405 which takes advantage of the sparseness of the residuals data to reduce the overall data size and involves mapping data elements to an ordered quadtree. Such coupling of entropy coding and sparsification is described further in WO 2019/111004 but the precise details of such a process is not relevant to the understanding of the invention. Each array of residuals may be thought of as an echelon.

The process set out above corresponds to an encoding process suitable for encoding data for reconstruction according to SMPTE ST 2117, VC-6 Multiplanar Picture Format. VC-6 is a flexible, multi-resolution, intra-only bitstream format, capable of compressing any ordered set of integer element grids, each of independent size but is also designed for picture compression. It employs data agnostic techniques for compression and is capable of compressing low or high bit-depth pictures. The bitstream's headers can contain a variety of metadata about the picture.

As will be understood, each echelon or echelon index may be implemented using a separate encoder or encoding operation. Similarly, an encoding module may be divided into the steps of down-sampling and comparing, to produce the residuals data, and subsequently encoding the residuals or alternatively each of the steps of the echelon may be implemented in a combined encoding module. Thus, the process may be for example be implemented using 4 encoders, one for each echelon index, 1 encoder and a plurality of encoding modules operating in parallel or series, or one encoder operating on different data sets repeatedly.

The following sets out an example of reconstructing an original data frame, the data frame having been encoded using the above exemplary process. This reconstruction process may be referred to as pyramidal reconstruction. Advantageously, the method provides an efficient technique for reconstructing an image encoded in a received set of data, which may be received by way of a data stream, for example, by way of individually decoding different component sets corresponding to different image size or resolution levels, and combining the image detail from one decoded component set with the upscaled decoded image data from a lower-resolution component set. Thus by performing this process for two or more component sets, digital images at the structure or detail therein may be reconstructed for progressively higher resolutions or greater numbers of pixels, without requiring the full or complete image detail of the highest-resolution component set to be received. Rather, the method facilitates the progressive addition of increasingly higher-resolution details while reconstructing an image from a lower-resolution component set, in a staged manner.

Moreover, the decoding of each component set separately facilitates the parallel processing of received component sets, thus improving reconstruction speed and efficiency in implementations wherein a plurality of processes is available.

Each resolution level corresponds to a level of quality or echelon index. This is a collective term, associated with a plane (in this example a representation of a grid of integer value elements) that describes all new inputs or received component sets, and the output reconstructed image for a cycle of index-m. The reconstructed image in echelon index zero, for instance, is the output of the final cycle of pyramidal reconstruction.

Pyramidal reconstruction may be a process of reconstructing an inverted pyramid starting from the initial echelon index and using cycles by new residuals to derive higher echelon indices up to the maximum quality, quality zero, at echelon index zero. A cycle may be thought of as a step in such pyramidal reconstruction, the step being identified by an index-m. The step typically comprises up-sampling data output from a possible previous step, for instance, upscaling the decoded first component set, and takes new residual data as further inputs in order to obtain output data to be up-sampled in a possible following step. Where only first and second component sets are received, the number of echelon indices will be two, and no possible following step is present. However, in examples where the number of component sets, or echelon indices, is three or greater, then the output data may be progressively upsampled in the following steps.

The first component set typically corresponds to the initial echelon index, which may be denoted by echelon index 1-N, where N is the number of echelon indices in the plane.

Typically, the upscaling of the decoded first component set comprises applying an upsampler to the output of the decoding procedure for the initial echelon index. In examples, this involves bringing the resolution of a reconstructed picture output from the decoding of the initial echelon index component set into conformity with the resolution of the second component set, corresponding to 2-N. Typically, the upscaled output from the lower echelon index component set corresponds to a predicted image at the higher echelon index resolution. Owing to the lower-resolution initial echelon index image and the up-sampling process, the predicted image typically corresponds to a smoothed or blurred picture.

Adding to this predicted picture higher-resolution details from the echelon index above provides a combined, reconstructed image set. Advantageously, where the received component sets for one or more higher-echelon index component sets comprise residual image data, or data indicating the pixel value differences between upscaled predicted pictures and original, uncompressed, or pre-encoding images, the amount of received data required in order to reconstruct an image or data set of a given resolution or quality may be considerably less than the amount or rate of data that would be required in order to receive the same quality image using other techniques. Thus, by combining low-detail image data received at lower resolutions with progressively greater-detail image data received at increasingly higher resolutions in accordance with the method, data rate requirements are reduced.

Typically, the set of encoded data comprises one or more further component sets, wherein each of the one or more further component sets corresponds to a higher image resolution than the second component set, and wherein each of the one or more further component sets corresponds to a progressively higher image resolution, the method comprising, for each of the one or more further component sets, decoding the component set so as to obtain a decoded set, the method further comprising, for each of the one or more further component sets, in ascending order of corresponding image resolution: upscaling the reconstructed set having the highest corresponding image resolution so as to increase the corresponding image resolution of the reconstructed set to be equal to the corresponding image resolution of the further component set, and combining the reconstructed set and the further component set together so as to produce a further reconstructed set.

In this way, the method may involve taking the reconstructed image output of a given component set level or echelon index, upscaling that reconstructed set, and combining it with the decoded output of the component set or echelon index above, to produce a new, higher resolution reconstructed picture. It will be understood that this may be performed repeatedly, for progressively higher echelon indices, depending on the total number of component sets in the received set.

In typical examples, each of the component sets corresponds to a progressively higher image resolution, wherein each progressively higher image resolution corresponds to a factor-of-four increase in the number of pixels in a corresponding image. Typically, therefore, the image size corresponding to a given component set is four times the size or number of pixels, or double the height and double the width, of the image corresponding to the component set below, that is the component set with the echelon index one less than the echelon index in question. A received set of component sets in which the linear size of each corresponding image is double with respect to the image size below may facilitate more simple upscaling operations, for example.

In the illustrated example, the number of further component sets is two. Thus, the total number of component sets in the received set is four. This corresponds to the initial echelon index being echelon-3.

The first component set may correspond to image data, and the second and any further component sets correspond to residual image data. As noted above, the method provides particularly advantageous data rate requirement reductions for a given image size in cases where the lowest echelon index, that is the first component set, contains a low resolution, or down sampled, version of the image being transmitted. In this way, with each cycle of reconstruction, starting with a low resolution image, that image is upscaled so as to produce a high resolution albeit smoothed version, and that image is then improved by way of adding the differences between that upscaled predicted picture and the actual image to be transmitted at that resolution, and this additive improvement may be repeated for each cycle. Therefore, each component set above that of the initial echelon index needs only contain residual data in order to reintroduce the information that may have been lost in down sampling the original image to the lowest echelon index.

The method provides a way of obtaining image data, which may be residual data, upon receipt of a set containing data that has been compressed, for example, by way of decomposition, quantization, entropy-encoding, and sparsification, for instance. The sparsification step is particularly advantageous when used in connection with sets for which the original or pre-transmission data was sparse, which may typically correspond to residual image data. A residual may be a difference between elements of a first image and elements of a second image, typically co-located. Such residual image data may typically have a high degree of sparseness. This may be thought of as corresponding to an image wherein areas of detail are sparsely distributed amongst areas in which details are minimal, negligible, or absent. Such sparse data may be described as an array of data wherein the data are organised in at least a two-dimensional structure (e.g., a grid), and wherein a large portion of the data so organised are zero (logically or numerically) or are considered to be below a certain threshold. Residual data are just one example. Additionally, metadata may be sparse and so be reduced in size to a significant degree by this process. Sending data that has been sparsified allows a significant reduction in required data rate to be achieved by way of omitting to send such sparse areas, and instead reintroducing them at appropriate locations within a received byteset at a decoder.

Typically, the entropy-decoding, de-quantizing, and directional composition transform steps are performed in accordance with parameters defined by an encoder or a node from which the received set of encoded data is sent. For each echelon index, or component set, the steps serve to decode image data so as to arrive at a set which may be combined with different echelon indices as per the technique disclosed above, while allowing the set for each level to be transmitted in a data-efficient manner.

There may also be provided a method of reconstructing a set of encoded data according to the method disclosed above, wherein the decoding of each of the first and second component sets is performed according to the method disclosed above. Thus, the advantageous decoding method of the present disclosure may be utilised for each component set or echelon index in a received set of image data and reconstructed accordingly.

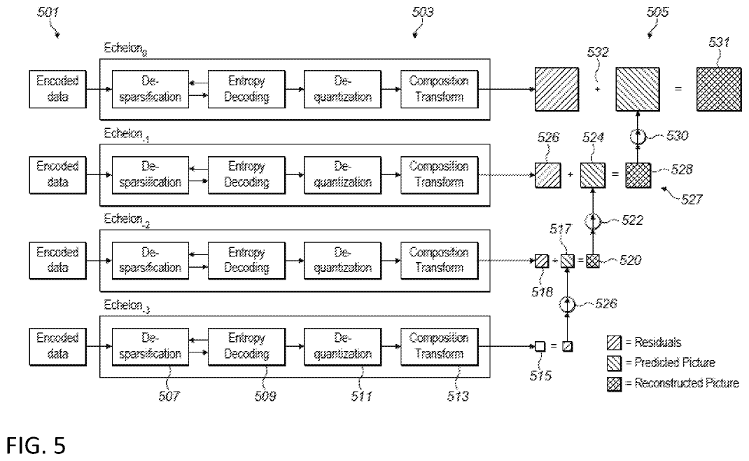

With reference to FIG. 5, a decoding example is now described. A set of encoded data 501 is received, wherein the set comprises four echelon indices, each echelon index comprising four echelons: from echelono, the highest resolution or level of quality, to echelon₋₃, the initial echelon. The image data carried in the echelon₋₃ component set corresponds to image data, and the other component sets contain residual data for that transmitted image. While each of the levels may output data that can be considered as residuals, the residuals in the initial echelon level, that is echelon₋₃, effectively correspond to the actual reconstructed image. At stage 503, each of the component sets is processed in parallel so as to decode that encoded set.

With reference to the initial echelon index, or the core-echelon index, the following decoding steps are carried out for each component set echelon₋₃ to echelon₀.

At step 507, the component set is de-sparsified. De-sparsification may be an optional step that is not performed in other tier-based hierarchical formats. In this example, the de-sparsification causes a sparse two-dimensional array to be recreated from the encoded byteset received at each echelon. Zero values grouped at locations within the two-dimensional array which were not received (owing to their being omitted from the transmitted byteset in order to reduce the quantity of data transmitted) are repopulated by this process. Non-zero values in the array retain their correct values and positions within the recreated two-dimensional array, with the de-sparsification step repopulating the transmitted zero values at the appropriate locations or groups of locations therebetween.

At step 509, a range decoder, the configured parameters of which correspond to those using which the transmitted data was encoded prior to transmission, is applied to the de-sparsified set at each echelon in order to substitute the encoded symbols within the array with pixel values. The encoded symbols in the received set are substituted for pixel values in accordance with an approximation of the pixel value distribution for the image. The use of an approximation of the distribution, that is relative frequency of each value across all pixel values in the image, rather than the true distribution, permits a reduction in the amount of data required to decode the set, since the distribution information is required by the range decoder in order to carry out this step. As described in the present disclosure, the steps of de-sparsification and range decoding are interdependent, rather than sequential. This is indicated by the loop formed by the arrows in the flow diagram.

At step 511, the array of values is de-quantized. This process is again carried out in accordance with the parameters with which the decomposed image was quantized prior to transmission.

Following de-quantization, the set is transformed at step 513 by a composition transform which comprises applying an inverse directional decomposition operation to the de-quantized array. This causes the directional filtering, according to an operator set comprising average, horizontal, vertical, and diagonal operators, to be reversed, such that the resultant array is image data for echelon₋₃ and residual data for echelon₋₂ to echelono.

Stage 505 illustrates the several cycles involved in the reconstruction utilising the output of the composition transform for each of the echelon component sets 501. Stage 515 indicates the reconstructed image data output from the decoder 503 for the initial echelon. In an example, the reconstructed picture 515 has a resolution of 64×64. At 516, this reconstructed picture is up-sampled so as to increase its constituent number of pixels by a factor of four, thereby a predicted picture 517 having a resolution of 128×128 is produced. At stage 520, the predicted picture 517 is added to the decoded residuals 518 from the output of the decoder at echelon₋₂. The addition of these two 128×128-size images produces a 128×128-size reconstructed image, containing the smoothed image detail from the initial echelon enhanced by the higher-resolution detail of the residuals from echelon₋₂. This resultant reconstructed picture 519 may be output or displayed if the required output resolution is that corresponding to echelon₋₂. In the present example, the reconstructed picture 519 is used for a further cycle. At step 512, the reconstructed image 519 is up-sampled in the same manner as at step 516, so as to produce a 256×256-size predicted picture 524. This is then combined at step 528 with the decoded echelon₋₁ output 526, thereby producing a 256×256-size reconstructed picture 527 which is an upscaled version of prediction 519 enhanced with the higher-resolution details of residuals 526. At 530 this process is repeated a final time, and the reconstructed picture 527 is upscaled to a resolution of 512×512, for combination with the echelon₀ residual at stage 532. Thereby a 512×512 reconstructed picture 531 is obtained.

A further hierarchical coding technology with which the principles of the present invention may be utilised is illustrated in FIGS. 6 and 7. This technology is a flexible, adaptable, highly efficient and computationally inexpensive coding format which combines a different video coding format, a base codec, (e.g., AVC, HEVC, or any other present or future codec) with at least two enhancement levels of coded data.

The general structure of the encoding scheme uses a down-sampled source signal encoded with a base codec, adds a first level of correction data to the decoded output of the base codec to generate a corrected picture, and then adds a further level of enhancement data to an up-sampled version of the corrected picture. Thus, the streams are considered to be a base stream and an enhancement stream, which may be further multiplexed or otherwise combined to generate an encoded data stream. In certain cases, the base stream and the enhancement stream may be transmitted separately. References to an encoded data as described herein may refer to the enhancement stream or a combination of the base stream and the enhancement stream. The base stream may be decoded by a hardware decoder while the enhancement stream may be suitable for software processing implementation with suitable power consumption. This general encoding structure creates a plurality of degrees of freedom that allow great flexibility and adaptability to many situations, thus making the coding format suitable for many use cases including OTT transmission, live streaming, live ultra-high-definition UHD broadcast, and so on. Although the decoded output of the base codec is not intended for viewing, it is a fully decoded video at a lower resolution, making the output compatible with existing decoders and, where considered suitable, also usable as a lower resolution output.

In certain examples, each or both enhancement streams may be encapsulated into one or more enhancement bitstreams using a set of Network Abstraction Layer Units (NALUs). The NALUs are meant to encapsulate the enhancement bitstream in order to apply the enhancement to the correct base reconstructed frame. The NALU may for example contain a reference index to the NALU containing the base decoder reconstructed frame bitstream to which the enhancement has to be applied. In this way, the enhancement can be synchronised to the base stream and the frames of each bitstream combined to produce the decoded output video (i.e. the residuals of each frame of enhancement level are combined with the frame of the base decoded stream). A group of pictures may represent multiple NALUs.

Returning to the initial process described above, where a base stream is provided along with two levels (or sub-levels) of enhancement within an enhancement stream, an example of a generalised encoding process is depicted in the block diagram of FIG. 6. An input video 600 at an initial resolution is processed to generate various encoded streams 601, 602, 603. A first encoded stream (encoded base stream) is produced by feeding a base codec (e.g., AVC, HEVC, or any other codec) with a down-sampled version of the input video. The encoded base stream may be referred to as the base layer or base level. A second encoded stream (encoded level 1 stream) is produced by processing the residuals obtained by taking the difference between a reconstructed base codec video and the down-sampled version of the input video. A third encoded stream (encoded level 2 stream) is produced by processing the residuals obtained by taking the difference between an up-sampled version of a corrected version of the reconstructed base coded video and the input video. In certain cases, the components of FIG. 6 may provide a general low complexity encoder. In certain cases, the enhancement streams may be generated by encoding processes that form part of the low complexity encoder and the low complexity encoder may be configured to control an independent base encoder and decoder (e.g., as packaged as a base codec). In other cases, the base encoder and decoder may be supplied as part of the low complexity encoder. In one case, the low complexity encoder of FIG. 6 may be seen as a form of wrapper for the base codec, where the functionality of the base codec may be hidden from an entity implementing the low complexity encoder.

A down-sampling operation illustrated by down-sampling component 605 may be applied to the input video to produce a down-sampled video to be encoded by a base encoder 613 of a base codec. The down-sampling can be done either in both vertical and horizontal directions, or alternatively only in the horizontal direction. The base encoder 613 and a base decoder 614 may be implemented by a base codec (e.g., as different functions of a common codec). The base codec, and/or one or more of the base encoder 613 and the base decoder 614 may comprise suitably configured electronic circuitry (e.g., a hardware encoder/decoder) and/or computer program code that is executed by a processor.

Each enhancement stream encoding process may not necessarily include an upsampling step. In FIG. 6 for example, the first enhancement stream is conceptually a correction stream while the second enhancement stream is upsampled to provide a level of enhancement.

Looking at the process of generating the enhancement streams in more detail, to generate the encoded Level 1 stream, the encoded base stream is decoded by the base decoder 614 (i.e. a decoding operation is applied to the encoded base stream to generate a decoded base stream). Decoding may be performed by a decoding function or mode of a base codec. The difference between the decoded base stream and the down-sampled input video is then created at a level 1 comparator 610 (i.e. a subtraction operation is applied to the down-sampled input video and the decoded base stream to generate a first set of residuals). The output of the comparator 610 may be referred to as a first set of residuals, e.g. a surface or frame of residual data, where a residual value is determined for each picture element at the resolution of the base encoder 613, the base decoder 614 and the output of the down-sampling block 605.

The difference is then encoded by a first encoder 615 (i.e. a level 1 encoder) to generate the encoded Level 1 stream 602 (i.e. an encoding operation is applied to the first set of residuals to generate a first enhancement stream).

As noted above, the enhancement stream may comprise a first level of enhancement 602 and a second level of enhancement 603. The first level of enhancement 602 may be considered to be a corrected stream, e.g. a stream that provides a level of correction to the base encoded/decoded video signal at a lower resolution than the input video 600. The second level of enhancement 603 may be considered to be a further level of enhancement that converts the corrected stream to the original input video 600, e.g. that applies a level of enhancement or correction to a signal that is reconstructed from the corrected stream.

In the example of FIG. 6, the second level of enhancement 603 is created by encoding a further set of residuals. The further set of residuals are generated by a level 2 comparator 619. The level 2 comparator 619 determines a difference between an upsampled version of a decoded level 1 stream, e.g. the output of an upsampling component 617, and the input video 600. The input to the up-sampling component 617 is generated by applying a first decoder (i.e. a level 1 decoder) to the output of the first encoder 615. This generates a decoded set of level 1 residuals. These are then combined with the output of the base decoder 614 at summation component 620. This effectively applies the level 1 residuals to the output of the base decoder 614. It allows for losses in the level 1 encoding and decoding process to be corrected by the level 2 residuals. The output of summation component 620 may be seen as a simulated signal that represents an output of applying level 1 processing to the encoded base stream 601 and the encoded level 1 stream 602 at a decoder.

As noted, an upsampled stream is compared to the input video which creates a further set of residuals (i.e. a difference operation is applied to the upsampled re-created stream to generate a further set of residuals). The further set of residuals are then encoded by a second encoder 621 (i.e. a level 2 encoder) as the encoded level 2 enhancement stream (i.e. an encoding operation is then applied to the further set of residuals to generate an encoded further enhancement stream).

Thus, as illustrated in FIG. 6 and described above, the output of the encoding process is a base stream 601 and one or more enhancement streams 602, 603 which preferably comprise a first level of enhancement and a further level of enhancement. The three streams 601, 602 and 603 may be combined, with or without additional information such as control headers, to generate a combined stream for the video encoding framework that represents the input video 600. It should be noted that the components shown in FIG. 6 may operate on blocks or coding units of data, e.g. corresponding to 2×2 or 4×4 portions of a frame at a particular level of resolution. The components operate without any inter-block dependencies, hence they may be applied in parallel to multiple blocks or coding units within a frame. This differs from comparative video encoding schemes wherein there are dependencies between blocks (e.g., either spatial dependencies or temporal dependencies). The dependencies of comparative video encoding schemes limit the level of parallelism and require a much higher complexity.

A corresponding generalised decoding process is depicted in the block diagram of FIG. 7. FIG. 7 may be said to show a low complexity decoder that corresponds to the low complexity encoder of FIG. 6. The low complexity decoder receives the three streams 601, 602, 603 generated by the low complexity encoder together with headers 704 containing further decoding information. The encoded base stream 601, 701 is decoded by a base decoder 710 corresponding to the base codec used in the low complexity encoder. The encoded level 1 stream 602, 702 is received by a first decoder 711 (i.e. a level 1 decoder), which decodes a first set of residuals as encoded by the first encoder 615 of FIG. 6. At a first summation component 712, the output of the base decoder 710 is combined with the decoded residuals obtained from the first decoder 711. The combined video, which may be said to be a level 1 reconstructed video signal, is upsampled by upsampling component 713. The encoded level 2 stream 703 is received by a second decoder 714 (i.e. a level 2 decoder). The second decoder 714 decodes a second set of residuals as encoded by the second encoder 621 of FIG. 6.

Although the headers 704 are shown in FIG. 7 as being used by the second decoder 714, they may also be used by the first decoder 711 as well as the base decoder 710. The output of the second decoder 714 is a second set of decoded residuals. These may be at a higher resolution to the first set of residuals and the input to the upsampling component 713. At a second summation component 715, the second set of residuals from the second decoder 714 are combined with the output of the up-sampling component 713, i.e. an up-sampled reconstructed level 1 signal, to reconstruct decoded video 750.

As per the low complexity encoder, the low complexity decoder of FIG. 7 may operate in parallel on different blocks or coding units of a given frame of the video signal. Additionally, decoding by two or more of the base decoder 710, the first decoder 711 and the second decoder 714 may be performed in parallel. This is possible as there are no inter-block dependencies.

In the decoding process, the decoder may parse the headers 704 (which may contain global configuration information, picture or frame configuration information, and data block configuration information) and configure the low complexity decoder based on those headers. In order to re-create the input video, the low complexity decoder may decode each of the base stream, the first enhancement stream and the further or second enhancement stream. The frames of the stream may be synchronised and then combined to derive the decoded video 750. The decoded video 750 may be a lossy or lossless reconstruction of the original input video 600 depending on the configuration of the low complexity encoder and decoder. In many cases, the decoded video 750 may be a lossy reconstruction of the original input video 600 where the losses have a reduced or minimal effect on the perception of the decoded video 750.

In each of FIGS. 6 and 7, the level 2 and level 1 encoding operations may include the steps of transformation, quantization and entropy encoding (e.g., in that order). These steps may be implemented in a similar manner to the operations shown in FIGS. 4 and 5. The encoding operations may also include residual ranking, weighting and filtering. Similarly, at the decoding stage, the residuals may be passed through an entropy decoder, a de-quantizer and an inverse transform module (e.g., in that order). Any suitable encoding and corresponding decoding operation may be used. Preferably however, the level 2 and level 1 encoding steps may be performed in software (e.g., as executed by one or more central or graphical processing units in an encoding device).

The transform as described herein may use a directional decomposition transform such as a Hadamard-based transform. Both may comprise a small kernel or matrix that is applied to flattened coding units of residuals (i.e. 2×2 or 4×4 blocks of residuals). More details on the transform can be found for example in patent applications PCT/EP2013/059847, published as WO 2013/171173, or PCT/GB2017/052632, published as WO 2018/046941, which are incorporated herein by reference. The encoder may select between different transforms to be used, for example between a size of kernel to be applied.

The transform may transform the residual information to four surfaces. For example, the transform may produce the following components or transformed coefficients: average, vertical, horizontal and diagonal. A particular surface may comprise all the values for a particular component, e.g. a first surface may comprise all the average values, a second all the vertical values and so on. As alluded to earlier in this disclosure, these components that are output by the transform may be taken in such embodiments as the coefficients to be quantized in accordance with the described methods. A quantization scheme may be useful to create the residual signals into quanta, so that certain variables can assume only certain discrete magnitudes. Entropy encoding in this example may comprise run length encoding (RLE), then processing the encoded output is processed using a Huffman encoder. In certain cases, only one of these schemes may be used when entropy encoding is desirable.

In summary, the methods and apparatuses herein are based on an overall approach which is built over an existing encoding and/or decoding algorithm (such as MPEG standards such as AVC/H.264, HEVC/H.265, etc. as well as non-standard algorithm such as VP9, AV1, and others) which works as a baseline for an enhancement layer which works accordingly to a different encoding and/or decoding approach. The idea behind the overall approach of the examples is to hierarchically encode/decode the video frame as opposed to the use block-based approaches as used in the MPEG family of algorithms. Hierarchically encoding a frame includes generating residuals for the full frame, and then a decimated frame and so on.

As indicated above, the processes may be applied in parallel to coding units or blocks of a colour component of a frame as there are no inter-block dependencies. The encoding of each colour component within a set of colour components may also be performed in parallel (e.g., such that the operations are duplicated according to (number of frames)*(number of colour components)*(number of coding units per frame)). It should also be noted that different colour components may have a different number of coding units per frame, e.g. a luma (e.g., Y) component may be processed at a higher resolution than a set of chroma (e.g., U or V) components as human vision may detect lightness changes more than colour changes.

Thus, as illustrated and described above, the output of the decoding process is an (optional) base reconstruction, and an original signal reconstruction at a higher level. This example is particularly well-suited to creating encoded and decoded video at different frame resolutions. For example, the input signal may be an HD video signal comprising frames at 920×1080 resolution. In certain cases, the base reconstruction and the level 2 reconstruction may both be used by a display device. For example, in cases of network traffic, the level 2 stream may be disrupted more than the level 1 and base streams (as it may contain up to 4× the amount of data where down-sampling reduces the dimensionality in each direction by 2). In this case, when traffic occurs the display device may revert to displaying the base reconstruction while the level 2 stream is disrupted (e.g., while a level 2 reconstruction is unavailable), and then return to displaying the level 2 reconstruction when network conditions improve. A similar approach may be applied when a decoding device suffers from resource constraints, e.g. a set-top box performing a systems update may have an operation base decoder to output the base reconstruction but may not have processing capacity to compute the level 2 reconstruction.

The encoding arrangement also enables video distributors to distribute video to a set of heterogeneous devices; those with just a base decoder view the base reconstruction, whereas those with the enhancement level may view a higher-quality level 2 reconstruction. In comparative cases, two full video streams at separate resolutions were required to service both sets of devices. As the level 2 and level 1 enhancement streams encode residual data, the level 2 and level 1 enhancement streams may be more efficiently encoded, e.g. distributions of residual data typically have much of their mass around 0 (i.e. where there is no difference) and typically take on a small range of values about 0. This may be particularly the case following quantization. In contrast, full video streams at different resolutions will have different distributions with a non-zero mean or median that require a higher bit rate for transmission to the decoder. In the examples described herein residuals are encoded by an encoding pipeline. This may include transformation, quantization and entropy encoding operations. It may also include residual ranking, weighting and filtering. Residuals are then transmitted to a decoder, e.g. as L-1 and L-2 enhancement streams, which may be combined with a base stream as a hybrid stream (or transmitted separately). In one case, a bit rate is set for a hybrid data stream that comprises the base stream and both enhancements streams, and then different adaptive bit rates are applied to the individual streams based on the data being processed to meet the set bit rate (e.g., high-quality video that is perceived with low levels of artefacts may be constructed by adaptively assigning a bit rate to different individual streams, even at a frame by frame level, such that constrained data may be used by the most perceptually influential individual streams, which may change as the image data changes).

The sets of residuals as described herein may be seen as sparse data, e.g. in many cases there is no difference for a given pixel or area and the resultant residual value is zero. When looking at the distribution of residuals much of the probability mass is allocated to small residual values located near zero-e.g. for certain videos values of −2, −1, 0, 1, 2 etc. occur the most frequently. In certain cases, the distribution of residual values is symmetric or near symmetric about 0. In certain test video cases, the distribution of residual values was found to take a shape similar to logarithmic or exponential distributions (e.g., symmetrically or near symmetrically) about 0. The exact distribution of residual values may depend on the content of the input video stream.

Residuals may be treated as a two-dimensional image in themselves, e.g. a delta image of differences. Seen in this manner the sparsity of the data may be seen to relate features like “dots”, small “lines”, “edges”, “corners”, etc. that are visible in the residual images. It has been found that these features are typically not fully correlated (e.g., in space and/or in time). They have characteristics that differ from the characteristics of the image data they are derived from (e.g., pixel characteristics of the original video signal).

As the characteristics of residuals differ from the characteristics of the image data they are derived from it is generally not possible to apply standard encoding approaches, e.g. such as those found in traditional Moving Picture Experts Group (MPEG) encoding and decoding standards. For example, many comparative schemes use large transforms (e.g., transforms of large areas of pixels in a normal video frame). Due to the characteristics of residuals, e.g. as described above, it would be very inefficient to use these comparative large transforms on residual images. For example, it would be very hard to encode a small dot in a residual image using a large block designed for an area of a normal image.

Certain examples described herein address these issues by instead using small and simple transform kernels (e.g., 2×2 or 4×4 kernels as presented herein). The transform described herein may be applied using a Hadamard matrix (e.g., a 4×4 matrix for a flattened 2×2 coding block or a 16×16 matrix for a flattened 4×4 coding block). This moves in a different direction from comparative video encoding approaches. Applying these new approaches to blocks of residuals generates compression efficiency. For example, certain transforms generate uncorrelated transformed coefficients (e.g., in space) that may be efficiently compressed. While correlations between transformed coefficients may be exploited, e.g. for lines in residual images, these can lead to encoding complexity, which is difficult to implement on legacy and low-resource devices, and often generates other complex artefacts that need to be corrected. Pre-processing residuals by setting certain residual values to 0 (i.e. not forwarding these for processing) may provide a controllable and flexible way to manage bitrates and stream bandwidths, as well as resource use.

### Examples Relating to Signal Processing Methods

In examples that will be described in more detail below. First and second signals are processed. The second signal comprises overlay content. The first signal does not comprise that overlay content. The first signal may be processed and output without the overlay content. The second signal may be processed to generate residual data. The residual data may be combined with the first signal (and/or a processed version of the first signal) to generate the second signal having the overlay content. As such, the overlay content can selectively be made available to one set of recipients and not to another set of recipients, but with both sets of recipients using the first signal as a base signal.

Specific examples will now be described in the context of SDR and HDR content, it being understood that examples described herein are appliable to other types of content.

For example, the overlay content may be an (SDR) advert. One group of consumers (for example without a subscription) would see this overlay, whereas another group of consumers (for example premium users with a subscription) would not see the overlay.

Another example is regional and/or geographic content, for example where the content differs in different countries. A content provider may wish to encode a base layer once, and then overlay a UK-specific overlay in the UK, and a Germany-specific overlay in Germany, for example.

In another example, the overlay content comprises (different) timer content. For example, in the US there are multiple time zones. A broadcaster may use different overlays to display the local time in the time zone in which content is being consumed, using different overlays for the different time zones.

Therefore, in example embodiments, obtaining the second signal (i.e. the signal comprising the overlay region) comprises determining one or more of: an attribute of a user (e.g. a subscription level of the user, a location of the user, a time zone of the user, a user's marketing preferences, and so forth); and an attribute of an entity associated with the method of signal processing (e.g. an entity performing said method, an entity outputting the encoded residual data, an entity transmitting the signal, an entity responsible for creating the content on which the signal is based on, a distributor of the signal, a broadcaster associated with the signal, and so forth) and selecting the second signal based on said determining. In this manner, an overlay may be selected that is associated with one or more of the user or an entity associated with the method of signal processing. In such examples, the user may be considered to be the end consumer of the signal, for example, in embodiments where the signal is a video signal then the user is considered to be the viewer of the video.

HDR content may be referred to as HDR overlay. Moreover, the HDR overlay may referred to as an HDR image.

The expression ‘overlaid on’ (or similar) is used to describe content being ‘overlaid on’ other content. For example, the expression may be used to describe a first image being overlaid on a second image. This may be equivalent to the second image being overlaid with the first image. In these examples, the first image would be in the forefront, which is why the language ‘overlaid on’ is used.

The term ‘portion’ or ‘region’ may be used to describe a first image that is a portion of a further image. In this sense, a portion means that the first image is less than the entire further image. In other words, portion means a percentage less than 100%.

The term ‘rendition’ takes the meaning of a version, in accordance with the understood definition of the term ‘rendition’.

Embodiments described herein provide multiple advantages.

For example, as outlined above, not all video content is produced at HDR. For example, a provider of a video (e.g. a content provider such as a streaming service) may not wish to provide all of given content as HDR for various reasons. One reason may be concerns regarding compatibility of the end devices. A further reason may be that there may not be enough bandwidth to carry HDR for all content.

However, it would be advantageous if, for example, an HDR overlay could be overlaid on top of SDR content. Embodiments of the present disclosure provide solutions to this problem.

Embodiments of the present disclosure thus provide multiple advantageous.

For example, the overlay may be a static (e.g., an image or logo) advertisement or a dynamic advert (e.g., a video advertisement, GIF or similar). There are many advantages to such an overlay being in HDR. For example, the advert would stand out relative to SDR content and thus attract the attention of a viewer in a more efficient manner. A further advantage is that an HDR advertisement could have a wider gamut of colour and thus could be capable of resembling a logo more accurately than an SDR advertisement owing to the increased colour gamut.

In a further example, an overlay could be a timer (e.g., a countdown or a ticking clock). Having such an overlay in HDR would advantageously mean that the timer stands out (owing to the wider luminance and/or colour gamut) compared to the main SDR content of the video.

In another example, the HDR overlay relates to news content, for example a news reel or news channel.

Examples described herein can generate residuals indicative of differences between the SDR content and the HDR overlay. These residuals are then encoded by a hierarchical based encoder, such as using residual processing described in the LCEVC standard, to obtain an enhancement layer. The SDR content is encoded by a base encoder. A decoder is configured to decode the base encoded SDR content and the hierarchical-based encoded enhancement layer. The decoder is configured to combine the decoded SDR content and the decoded enhancement layer to produce an image comprising the SDR content overlaid with the HDR content.

The residuals may be generated in a number of different ways. The residuals may correspond to a representation of the HDR overlay. Such a representation may be obtained by processing only the HDR overlay, for example, obtained by quantising the HDR overlay.

The residuals may be generated by processing a rendition of the HDR content in conjunction with a rendition of the SDR content. The SDR content may be processed to obtain the rendition of the SDR content, for example, the original SDR image may be encoded and decoded and/or downscaled and upscaled to obtain the rendition of the SDR content. A difference between the rendition of the SDR content and a rendition of the HDR content may be computed. The rendition of the HDR content can be obtained in a number of ways. For example, the rendition of the HDR content may be obtained by superimposing the HDR content onto a representation of the SDR content. This representation could be the same as the original signal of the SDR content used to obtain the rendition of SDR content. Alternatively, this representation could be a higher resolution version of the original signal of the SDR content used to obtain the rendition of SDR content. Regardless of how it is obtained, the rendition of the HDR content is compared to the rendition of the SDR content to generate residuals.

The residuals are encoded using a hierarchical based encoding method, such as LCEVC. The details of how LCEVC processes residuals can be found in WO 2020/188273.

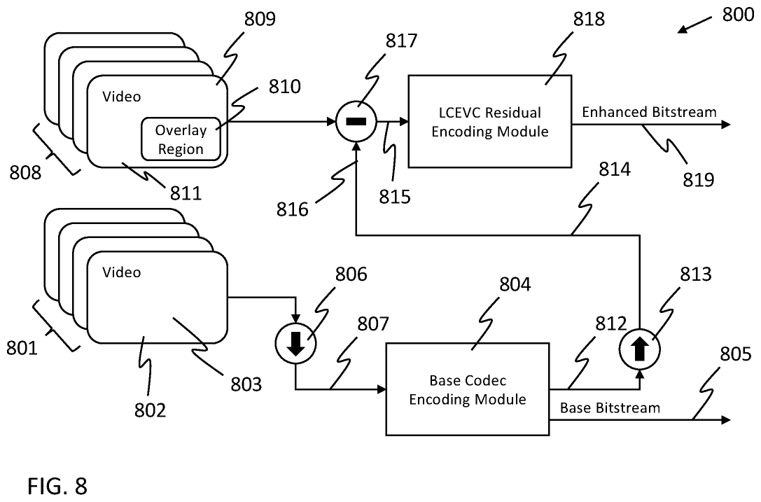

FIG. 8 illustrates an example signal processing method, in the form of an example encoding process 800. The example encoding process 800 may encode an image comprising HDR content (e.g. an image) overlaid onto an SDR image.

A first signal 801 is processed. In this example, the first signal 801 comprises a series of component signals 802. The first signal 801 comprises non-overlay region 803. The term “non-overlay region” is used to mean a region that is not an overlay region. A signal having a non-overlay region may or may not have an overlay region.

The first signal 801 is processed by at least sending the first signal 801 to an encoder 804. In this example, the encoder 804 comprises a base code encoding module and will therefore generally be referred to as the “base encoder”. The base encoder 804 encodes the first signal 801 to generate an encoded signal 805. In this example, the encoded signal 805 comprises an encoded base bitstream 805.

In this example, prior to being sent to the base encoder 804, the first signal 801 is down-sampled by a down-sampler 806. The output of the down-sampler 806 is a down-sampled signal 807. However, in other examples, the first signal 801 is not down- sampled prior to being encoded by the base encoder 804.

It will therefore be understood that processing the first signal 801 by at least sending the first signal to the base encoder 804 encompasses both (i) sending the first signal 801 itself to the base encoder 804 to be encoded and (ii) processing the first signal 801 and sending the first signal as-processed (e.g., the down-sampled signal 807) to the base encoder 804 to be encoded. Such processing may comprise down-sampling the first signal 801.

A second signal 808 is obtained. In this example, the second signal 808 comprises a series of component signals 809. The second signal 808 may be obtained in various different ways. For example, the second signal 808 may be received, retrieved from storage, generated, or may be obtained in another way.

The second signal 808 comprises an overlay region 810. The second signal 808 may comprise multiple overlay regions 810. The overlay region 810 of the second signal 808 comprises overlay content. The overlay content may take various different forms. In this example, the first signal 801 does not comprise said overlay content.

An overlay region, such as the overlay region 810 of the second signal 808, may be considered to be an Region of Interest (RoI). The RoI may comprise content of particular interest to an ultimate consumer (e.g., viewer) of the second signal 808 for example. The size of the RoI may, for example, be at most half the size of the second signal 808.

In some examples, the second signal 808 is generated by applying an overlay signal to an input signal. The overlay signal comprises the overlay region 810. The applying may comprise replacing, in the overlay region 810, signal element values of signal elements of the input signal with signal element values of signal elements of the overlay signal.

In some examples, the generating of the second signal 808 comprises identifying an ROI in an input signal. Where the input signal is SDR, the identified ROI may be encoded with HDR, with the remainder being maintained in SDR.

The second signal 808 comprises a non-overlay region 811. The second signal 808 may comprise multiple non-overlay regions 811.

In this example, the output of the base encoder 804, namely the encoded base bitstream 805 is processed. In this example, such processing of the encoded base bitstream 805 comprises decoding the encoded base bitstream 805 to generate a decoded version 812 of the encoded base bitstream 805. In this example, the base encoder 804 outputs both the encoded base bitstream 805 and the decoded version 812 of the encoded base bitstream 805. For example, the base encoder 804 may comprise decoding functionality to decode the encoded base bitstream 805. However, in other examples, a separate decoder (not shown) is used to decode the encoded base bitstream 805. The decoded version 812 of the encoded base bitstream 805 will generally be referred to simply as the decoded base bitstream 812.

In this example, the decoded base bitstream 812 is processed. In this example, such processing of the decoded base bitstream 812 comprises up-sampling the decoded base bitstream 812 by an up-sampler 813. The output of the up-sampler 813 is an up-sampled signal 814. However, in other examples, the decoded base bitstream 812 is not up-sampled in this manner, for example if the first signal 801 has not been down-sampled by the down-sampler 806.

At least the second signal 808 is processed to generate residual data 815. In this example, the second signal 808 and a third signal 816 are processed, by a residual generator 817, to generate the residual data 815. The third signal 816 may be a rendition of the first signal 801, i.e., the first signal 801 or a signal derived based on the first signal 801. In this example, the third signal 816 is based on the decoded base bitstream 812. The third signal 816 may comprise the decoded base bitstream 812 or may comprise the decoded base bitstream 812 as processed, i.e. the up-sampled signal 814. In this example, the third signal 814 comprises the decoded base bitstream 812 as processed, i.e. the up-sampled signal 814 which is an up-sampled version of the decoded base bitstream 812. In this example, the processing of the second signal 808 and the third signal 816 (i.e. the up-sampled signal 814) comprises calculating, by the residual generator 817, a difference between the second signal 808 and the third signal 816 (i.e. the up-sampled signal 814).

In this example, the residual generator 817 calculates differences between values of signal elements in at least the overlay region 810 of the second signal 808 and values of corresponding signal elements in the third signal 816.

The corresponding signal elements in the third signal 816 may or may not be in an overlay region of the third signal 816. In particular, in this example, the third signal 816 (and the first signal 801 based on which the third signal 816 is derived) does not comprise an overlay region. As such, the corresponding signal elements in the third signal 816 are not in an overlay region of the third signal 816.

The residual generator 817 may or may not calculate differences between values of signal elements outside the overlay region 810 of the second signal 808 and values of corresponding signal elements in the third signal 816.

In this example, the residual generator 817 calculates the differences by subtracting values of signal elements in the third signal 816 (i.e. the up-sampled signal 814) from values of corresponding signal elements in the second signal 808.

The residual data 815 may be indicative of the overlay content of the overlay region 810 of the second signal 808. For example, when the residual generator 817 calculate differences between values of signal elements in the overlay region 810 and values of corresponding signal elements in the third signal 816, the residual data 815 is influenced by the overlay content of the overlay region 810 of the second signal 808.

In some cases, the values of residuals derived based on the values of signal elements in the overlay region 810 of the second signal 808 are significantly larger than the values of residuals derived based on the values of signal elements in the non-overlay region 811 of the second signal 808. The (larger) values of residuals derived based on the values of signal elements in the overlay region 810 of the second signal 808 may be indicative of the overlay content of the overlay region 810 of the second signal 808.

In this example, the residual data 815 generated by the residual generator 817 is sent to an encoder 818 to be encoded. In this example, the encoder 818 is different from the base encoder 804. In this example, the encoder 818 comprises an LCEVC residual encoding module. In this example, the encoder 818 is at an enhancement level and will therefore generally be referred to as the “enhancement encoder”. The enhancement encoder 818 encodes the residual data 815 output by the residual generator 817 to generate encoded residual data. As such, in this example, a first codec is used to generate the encoded base bitstream 805 and a second, different codec is used to generate the encoded residual data. In this example, the encoded residual data is comprised in an encoded enhanced bitstream 819.

In this example, the example encoding process 800 outputs at least the encoded residual data. The example encoding process 800 may also output the encoded base bitstream 805 for example.

The example encoding process 800 may include one or more actions not shown in FIG. 8. For example, the residual data 815 output by the residual generator 817 may be subject to transformation and/or quantization. In some examples, the encoding process 800 may correct for any encoder-decoder errors introduced by the base encoder 804 in creating the encoded base bitstream and/or by a decoder (whether or not part of the base encoder 804) in decoding the encoded base bitstream 805.

Although, in this example, the example encoding process 800 includes the base encoder 804 encoding the first signal 801 to generate the encoded signal 805, in other examples, the example encoding process 800 sends the first signal 801 to a base encoder to be encoded, but does not perform the encoding of the first signal 801.

Additionally, although, in this example, the example encoding process 800 includes decoding the encoded base bitstream 805 output by the base encoder 804, in other examples, the example encoding process 800 receives the decoded base bitstream 812 from a decoder (whether or not part of the base encoder 804), but does not perform the decoding of the encoded base bitstream 805. Further, as explained above, although, in this example, the example encoding process 800 includes down-sampling and up-sampling, in other examples, the example encoding process 800 does not perform such down-sampling and/or up-sampling.

In this example, the first signal 801 comprises content having a first dynamic range. In this example, the second signal 808 comprises content having a second dynamic range. The content having the second dynamic range may be comprised in the overlay region 810 of the second signal 808 and/or in the non-overlay region 811 of the second signal 808. In this example, the second dynamic range is higher than the first dynamic range.

In this example, the overlay content (comprised in the overlay region 810 of the second signal 808) comprises or consists of HDR content. In this example, the first signal 801 comprises or consists of SDR content.

In some examples, the first codec (associated with the base encoder 804) would be unable to encode the overlay region 810 of the second signal 808. For example, the first codec (associated with the base encoder 804) may be unable to encode HDR content. The second codec (associated with the enhancement encoder 818) may, however, be able to encode HDR content. The first codec (associated with the base encoder 804) may be able to encode SDR content.

By way of a specific example, an advertising server may be able to encode an advert using LCEVC in HDR. The overlay content may comprise the HDR advert.

The base encoder 804 may use an SDR-capable (e.g. 8-bit) base codec, which is likely to be widely supported. The enhancement encoder 812 may use an HDR-capable (e.g. 10-bit) base codec, which is likely to be less widely supported. The HDR content can, in effect, be added via LCEVC.

In some examples, the overlay content comprised in the overlay region 810 of the second signal 808 is used to provide content to a group of one or more consumers (e.g., viewers) and not to another group of one or more consumers (e.g., viewers). As such, the difference in the type of content may relate to different intended consumers (whether or not the SDR and HDR difference also applies).

In some specific examples, the overlay content may be used, in effect, to replace at least some instances of one or more colours in the first signal 801 with one or more other colours. For example, the first signal 801 may comprise one or more colours that some consumers (e.g., viewers) find difficult to distinguish visually from one or more other colours. The overlay content may, in effect, replace such colour(s) with other colour(s) that can more readily be distinguished by such consumers (e.g., viewers). This example may also involve detection in order to detect which part(s) of a signal to change or overlay. In contrast, other examples described above (for example concerning location-specific overlay content, local time and the like may be less complex, as the overlay may be in a static position in the signal and may not involve any analysis of the signal before the overlay is selected.

In this example, the second signal 810 has a given level of quality. In this specific example, the given level of quality is the higher (or “enhancement”) level of quality. In this example, the given level of quality of the second signal 810 is maintained during the processing of the second signal 810. Such processing may be by the residual generator 817 or otherwise. In this example, the given level of quality of the second signal 810 is maintained at least in that the second signal 810 is not down-sampled to a lower level of quality.

In some examples, a further signal is obtained. The further signal comprises a further overlay region which comprises further overlay content. The further overlay content is different from the overlay content comprised in the overlay region 810 of the second signal 808. At least the further signal is processed to generate further residual data. The further residual data is encoded to generate further encoded residual data. The further encoded residual data is output in association with the encoded base bitstream 805. In such examples, different overlay content can be provided in association with the same encoded base bitstream 805. This may enable personalised overlay content to be provided.

As such, the overlay content and/or the further overlay content may be selected based on one or more overlay content selection criteria. Examples of such overlay content selection criteria include, but are not limited to, a location (for example of a consumer), a time zone (for example of a consumer), a subscription level (for example of a consumer).It is emphasised again that, although the example encoding process 800 is described in relation to an image comprising HDR content (e.g. an image) being overlaid onto an SDR image, this is merely one example of overlay content. The overlay content may comprise non-HDR content in other examples.

In some examples, the further encoded residual data is output with the encoded residual data. As such, a decoder receiving the encoded residual data and the further encoded residual data may be able to select between the encoded residual data and the further encoded residual data, for example based on one or more selection criteria.

For example, multiple overlays may be embedded or otherwise provided. A decoder may use user data information to select which one(s) to use depending on the region, user, etc. This may enable targeted and/or regional content.

In terms of decoder-side processing, a decoded signal (e.g., a decoded version of the encoded base bitstream 805) is processed (e.g., up-sampled) to generate a signal (e.g., corresponding to the third signal 816). Encoded residual data (e.g., comprised in the encoded enhanced bitstream 819) is processed by at least decoding the encoded residual data to generate decoded residual data (e.g. corresponding to the residual data 815). At least the generated signal and the decoded residual data are processed to generate another signal. Such processing may comprise combining the generated signal and the decoded residual data. The other generated signal may correspond to the above-mentioned second signal 808. In particular, the other generated signal comprises an overlay region (corresponding to the above-mentioned overlay region 810) comprising overlay content. The generated signal does not comprise the overlay content. The decoded residual data may be indicative of the overlay content of the overlay region of the other generated signal.

In principle, overlay content could be output as a separate overlay video stream (i.e., separate from the base video bitstream 805), where the separate overlay video stream comprises a transparency outside the overlay region 810. However, this may involve two full decodings; one for the base video bitstream 805 and another for the overlay video stream. Additionally, two decodings increases decoding process power requirements. Further, most legacy codecs do not support transparencies.

Overlay graphics could be sent as graphics to be drawn by a graphics engine. However, this again uses significantly more processing power. Additionally, in general, real-time graphics do not have the same visual quality as graphics that can be generated by a (post)-production system.

Examples described herein, which leverage LCEVC, can enable high-quality, power-efficient and legacy-codec-compatible overlays. Examples described herein, which can also leverage VC-6, can also provide such effects if used with transparencies.

In accordance with examples described herein, which leverage LCEVC, two input sources are used instead of one. See, for example, FIG. 6, which uses one input video 600 rather than two. In accordance with examples, one input source is a source video and another is an overlay video. Using LCEVC, instead of computing residuals based on the source video, residuals can be calculated based on the combination of the source video and the overlay video. As described herein, residuals may be additive or substitutive. One or more signalling bits may be used to signal whether given residuals are additive or substitutive. Embedded information may be used to signal where enhancement (using residuals) is to be intended to be substitutive rather than additive. Only decoders that understand the embedded information would be able to decode the videos fully. Others would still be able to decode some video. In some cases, substitutive overlay residuals may be sent as embedded signalling, with additive residuals signalled in a non-embedded manner.

A specific example of how the example encoding process 800 can be used in relation to SDR and HDR content will now be provided. This example encoding process 800 uses an LCEVC residual encoding module 818 and a base codec encoding module 804. The example encoding process 800 receives an SDR video signal 801. The SDR video signal 801 comprises a plurality of SDR images. The plurality of SDR images comprise a first SDR image 802. The SDR image 802 may be referred to as the image 802 of the SDR video signal 801. The example encoding process 800 also receives an HDR video signal 808. The HDR video signal 808 comprises a plurality of HDR images. One of the plurality of HDR images 808 is the HDR image 809. The HDR image 809 may be referred to as the image 809 of the HDR video signal 808. The HDR image 809 may be referred to as ‘HDR content’. The HDR image 809 may be received either on its own or as a combined image, wherein the combined image comprises the image of the HDR video signal 808 overlaid onto a version of the image of the SDR video signal 801. The version of the image of the SDR video signal 801 may be a higher resolution version of the image of the SDR video signal 801.

The base codec encoding module 804 receives the SDR image 802. The base codec encoding module 804 encodes the SDR image 802 using a base codec to generate an encoded version 805 of the SDR image 802. Examples of a base codec encoding module 804 include a module configured to encode the SDR image 802 in accordance with known codecs including VVC, EVC, AVC, HEVC. The base codec encoding module 804 is further configured to output the encoded SDR image 805. The outputted encoded version of the SDR image 805 may be referred to as a base bitstream 805. The base bitstream 805 may be decoded by decoder to obtain a decoded rendition of the SDR image 802.

The base codec encoding module 804 is further configured to generate and output a decoded rendition 812 of the encoded version 805 of the image 802 of the SDR video signal 801. This decoded rendition 812 is output to the residual calculating module 817. The residual calculating module 817 receives the decoded rendition 812 (or a rendition derived therefrom). The residual calculating module 817 also receives the HDR image 809. In particular, the residual calculating module 817 receives the HDR image 809 in the form of a rendition of said image 809 of the HDR video signal 808 overlaid onto a portion of said image 802 of the SDR image 801. In this example, the residual calculating module 817 is configured to receive the HDR image 809 in the form a rendition of the combined image. In examples, a rendition of an image may refer to a quantised version of the image. Other types of rendition of an image may be used.

The residual calculating module 817 generates residuals 815 based on the version of the combined image and the decoded rendition 814. In this example, the residual calculating module 817 is configured to generate the residuals 815 by calculating the difference between the decoded rendition 814 and the rendition of the combined image, where the combined image comprises the image 809 of the HDR video signal 808 overlaid onto a portion of the image of the version of the SDR image. In this way, the residual calculating module 817 generates residuals 815 that account for base-codec-related artefacts and further account for the HDR image 809. Therefore, by generating the residuals 815 in this manner, two advantages can be obtained via a single method.

The generated residuals 815 are then processed by the LCEVC residual encoding module 818. Details on how residuals are processed by the LCEVC residual code in module 818 can be found in the ‘LCEVC standard’, ISO/IEC 23094-2 (first published draft in January 2020), the contents of which are incorporated herein by reference. In general, such methods of processing residuals advantageously process residuals in an efficient manner. Thus, the known methods of processing residuals as described in the LCEVC standard can be leveraged to process the residuals 815 of the present disclosure to similar positive outcomes.

The result of the LCEVC residual encoding module 818 is output as an enhancement bit stream 819. The enhancement bitstream 819 is considered as an enhancement layer that can be used by a decoder in combination with the base bitstream 805 to generate a decoded SDR image having a(n overlay) portion that is HDR.

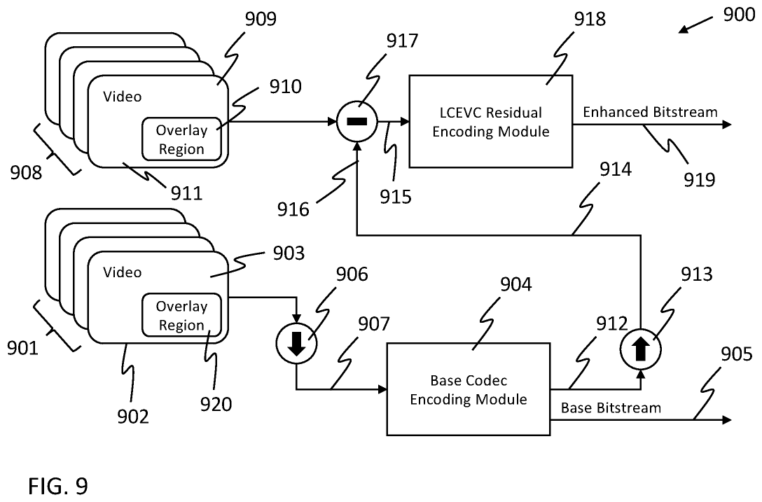

FIG. 9 illustrates another example signal processing method, in the form of an example encoding process 900. The example encoding process 900 may encode an image comprising HDR content (e.g. an image) overlaid onto a SDR image.

The example encoding process 900 shown in FIG. 9 is similar to the example encoding process 800 shown in FIG. 8. Like elements are shown using the same reference signs, but incremented by ‘100’.

In this example, the first signal 901 comprises an overlay region 920. In contrast, the first signal 801 described above with reference to FIG. 8 does not comprise an overlay region. In this example, the overlay region 920 of the first signal 901 comprises overlay content. In this example, as well as comprising the overlay region 920, the first signal 901 still comprises a non-overlay region 903.

In this example, the overlay region 920 of the first signal 901 may comprise SDR overlay content and the overlay region 910 of the second signal 908 may comprise HDR overlay content. The up-sampling 913 may involve tone-mapping, where the ton-mapping maps the SDR-based set of colours (e.g., 8-bit) to the HDR-based set of colours (e.g., 10-bit). This enables the residual generator 917 to calculate the difference between the values of the signal elements in the overlay regions 920, 910 of the first and second signals 901, 908 respectively.

A specific example of how the example encoding process 900 can be used in relation to SDR and HDR content will now be provided.

The example encoding process 900 receives an SDR video signal 901. The SDR video signal 901 comprises a plurality of SDR images. The plurality of SDR images comprises a combined SDR image 902. The SDR image 902 may be referred to as the image 902 of the SDR video signal 901. The combined SDR image 902 comprises an SDR image overlaid with SDR content 920. The SDR content 920 corresponds to HDR content 910, which is described below in further detail. The SDR content 920 is an SDR version of the HDR content 910. The HDR content 910 and the SDR content 920 can be considered to be overlays.

The example encoding process 900 receives an HDR video signal 908. The HDR video signal 908 comprises a plurality of images having at least a portion that is HDR. One of the plurality of HDR images is the HDR image 909. The HDR image 909 may be referred to as the image 909 of the HDR video signal. The HDR image 909 may be referred to as ‘HDR content’. The HDR image 909 may be received by the example encoding process 900 either on its own or as a combined image, wherein the combined image comprises the image 909 of the HDR video signal overlaid onto a version of the image 902 of the SDR video signal 901. The version of the image 902 of the SDR video signal may be a higher resolution version of the image 902 of the SDR video signal 901. The combined image thus corresponds to the SDR image 902. However, the combined image comprises a portion that is HDR (i.e. ‘HDR content’ 910) whereas the SDR image 902 comprises SDR content 920. Moreover, the combined image may be at a higher resolution than the SDR image 902.

The base codec encoding module 904 receives the SDR image 902. The base codec encoding module 904 encodes the SDR image 902 using a base codec to generate an encoded version 905 of the SDR image 902. Examples of a base codec encoding module 904 include a module configured to encode the SDR image 902 in accordance with known codecs including VVC, EVC, AVC, HEVC. The base codec encoding module 904 is further configured to output the encoded SDR image 905. The outputted encoded version of the SDR image 902 may be referred to as a base bitstream 905. A base bitstream may be decoded by decoder to obtain a decoded rendition of the SDR image 902.

The base codec encoding module 904 generates and outputs a decoded rendition 912 of the encoded version 905 of the SDR image 902.

This decoded rendition 912 is output to the residual calculating module 917. The residual calculating module 917 receives the decoded rendition 912 (or, in this example, an up-sampled version of the decoded rendition 912). The residual calculating module 917 further receives the HDR image 909. In this example, the residual calculating module 917 receives the HDR image 909 in the form of a rendition of the combined image.

The residual calculating module 917 generates residuals 915 based on the version of the combined image and the decoded rendition 912. In this example, the residual calculating module 917 generates the residuals 915 by calculating the difference between the decoded rendition 912 (or, more specifically, the up-sampled version thereof 914) and the version of the combined image. In this way, the residual calculating module 917 generates residuals 915 that account for base-codec-related artefacts and further account for the HDR content 910.

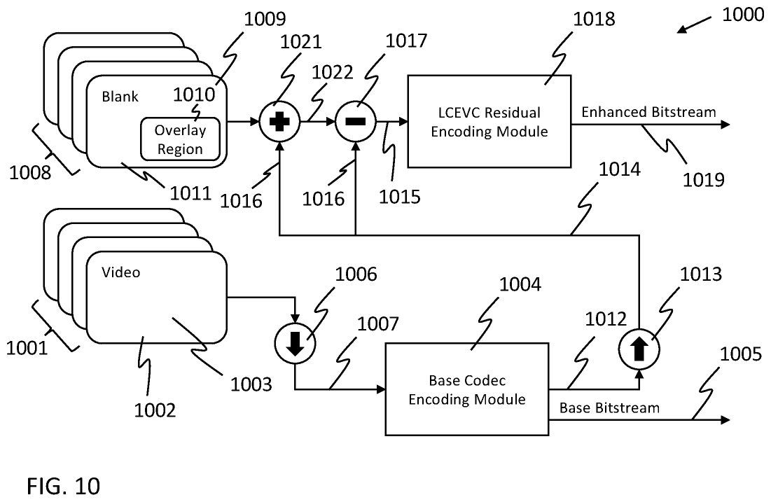

FIG. 10 illustrates another example signal processing method, in the form of an example encoding process 1000. The example encoding process 1000 may encode an image comprising HDR content (e.g. an image) overlaid onto a SDR image.

The example encoding process 1000 shown in FIG. 10 is similar to the example encoding process 800 shown in FIG. 8. Like elements are shown using the same reference signs, but incremented by ‘200’.

In this example, as with examples described above, the second signal 1008 comprises a non-overlay region 1011. However, in this example, the non-overlay region 1011 of the second signal 1008 is a blank (non-overlay) region. In this example, a blank region comprises signal elements whose values are all zero.

In this example, as with examples described above, the second signal 1008 and the third signal 1016 are processed to generate the residual data. However, in this example, values of signal elements in at least the overlay region 1010 of the second signal 1008 are combined, by a combiner 1021, with values of corresponding signal elements in the third signal 1016 to generate a combined signal 1021. In this specific example, the combining comprises adding the values together.

In addition, in this example, differences are calculated between values of signal elements in at least an overlay region of the combined signal 1021 and values of corresponding signal elements in the third signal 1016. The overlay region of the combined signal 1021 corresponds to the overlay region 1010 of the second signal 1008. The overlay region may correspond to each other in that they are in the same positions in their respective signals.

One particular feature of the example encoding process 1000 will be described in more detail now.

The combiner 1021 receives the second and third signals 1008 and 1016, which may be denoted ‘A’ and ‘B’ respectively, and outputs the combined signal 1022, which may be denoted ‘C’. The combining by the combiner 1021 may therefore be represented mathematically as: A+B=C.

The residual generator 1017 receives the combined and third signals 1022 and 1016, which may be denoted ‘C’ and ‘B’ respectively, and outputs residuals which are the difference between the combined signal 1022 and the third signal 1016 and which may be denoted ‘R’. The subtraction performed by the residual generator 1017 may be represented mathematically as: C−B=R.

Substituting A+B=C into C−B=R gives (A+B)−B=R, or A=R.

As such, the combining by the combiner 1021 and the difference calculation performed by the residual generator 1017 might be seen as redundant, or even inefficient, since they, in effect, cancel out the third signal 1016 (denoted ‘B’ above). In particular, in principle, the enhancement encoder 1018 could simply receive the second signal 1008 directly.

However, the enhancement encoder 1018 (and more generally a system in which it is located) may be designed and optimised to receive a signal that is calculated as a difference between two other signals. The example encoding process 1000 can therefore maintain compatibility with such an enhancement encoder 1018.

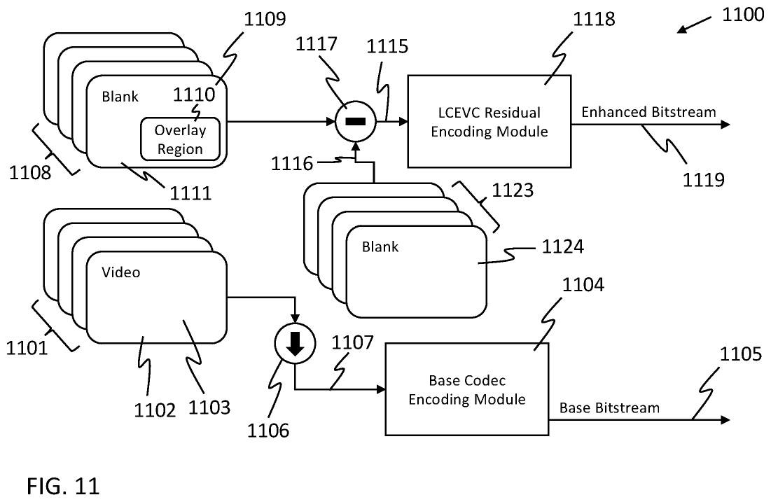

FIG. 11 illustrates another example signal processing method, in the form of an example encoding process 1100. The example encoding process 1100 may encode an image comprising HDR content (e.g. an image) overlaid onto a SDR image.

The example encoding process 1100 shown in FIG. 11 is similar to the example encoding process 800 shown in FIG. 8. Like elements are shown using the same reference signs, but incremented by ‘300’.

In this example, the third signal 1116 comprises a reference signal 1123. In this example, the reference signal 1123 is independent of the first signal 1101. In this example, the reference signal 1123 comprises a non-overlay region 1124. In this specific example, the reference signal 1123 is a blank signal.

Again, the difference calculation performed by the residual generator 1117 might be seen as redundant, or even inefficient, since it, in effect, does not alter the second signal 1108.

However, again, the enhancement encoder 1118 (and more generally a system in which it is located) may be designed and optimised to receive a signal that is calculated as a difference between two other signals. The example encoding process 1100 can therefore maintain compatibility with such an enhancement encoder 1118.

In this example, the residual data 1115 output by the residual generator 1117 comprises substitutive residual data. Substitutive residual data comprises signal element values to be substituted in place of corresponding signal element values in another signal. Substitutive residual data differs from additive residual data which comprises signal element values to be added to corresponding signal element values in another signal.

In this example, a decoder may decode (and potentially up-sample) the base bitstream 1105. The decoder may also decode the enhanced bitstream 1119. The decoder may then substitute signal element values of the substitutive residual data in place of corresponding signal element values of the decoded (and potentially up- sampled) base bitstream 1105.

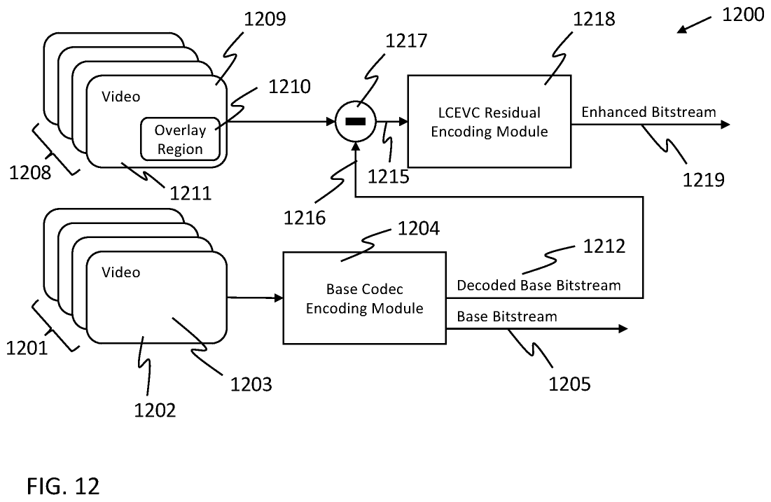

FIG. 12 illustrates another example signal processing method, in the form of an example encoding process 1200.

The example encoding process 1200 shown in FIG. 12 is similar to the example encoding process 800 shown in FIG. 8. Like elements are shown using the same reference signs, but incremented by ‘400’.

However, the example encoding process 800 does not comprise up-sampling or down-sampling. The first signal 1210 is processed by at least sending the first signal 1210 to the base encoder 1204. In this example, the first signal 1210 is not down- sampled prior to being encoded.

The second signal 1208 is obtained. The second signal 1208 comprises the overlay region 1210, which comprises overlay content. At least the second signal 1208 is processed to generate the residual data 1215. In this example, the third signal 1216 is processed with the second signal 1208 to generate the residual data 1215. In this example, the third signal 1216 comprises the decoded base bitstream 1212 and not an up-sampled version of the decoded base bitstream 1212. The residual data 1215 is encoded to generate encoded residual data. At least the encoded residual data is output.

In this example, the first signal 1201 has a given level of quality. The given level of quality of the first signal 1201 is maintained during processing of the first signal 1201. For example, in this example the first signal 1201 is neither down-sampled nor up-sampled.

As such, LCEVC may be used for overlays even where there is no scaling between base and enhancement layers.

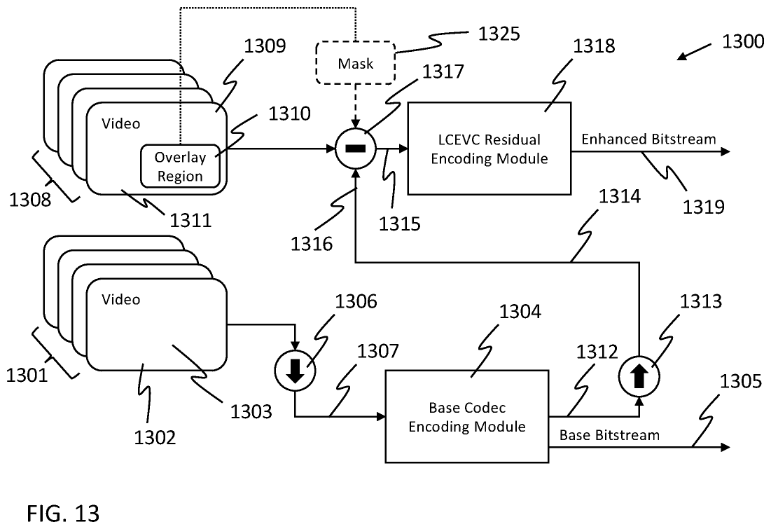

FIG. 13 illustrates another example signal processing method, in the form of an example encoding process 1300.

The example encoding process 1300 shown in FIG. 13 is similar to the example encoding process 800 shown in FIG. 8. Like elements are shown using the same reference signs, but incremented by ‘500’.

In this example, the residual generator 1317 uses mask data 1325 in generating the residual data 1315. In this example, the mask data 1325 identifies the overlay region 1310 of the second signal 1308. In this example, the residual generator 1317 uses the mask data 1325 such that (i) differences are calculated between values of signal elements in the non-overlay region 1311 of the second signal 1308 and values of corresponding signal elements of the third signal 1316 and (ii) values of signal elements in the overlay region 1310 of the second signal 1308 replace (or “substitute”) values of corresponding signal elements of the third signal 1316. The second signal 1308 may therefore comprise a portion (the overlay region 1310) intended to be used as substitutive and a portion (the non-overlay region 1311) intended to be used as additive.

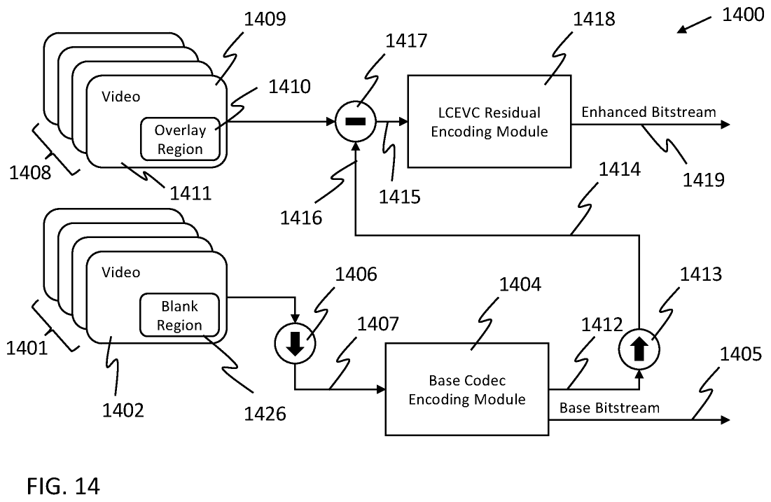

FIG. 14 illustrates another example signal processing method, in the form of an example encoding process 1400.

The example encoding process 1400 shown in FIG. 14 is similar to the example encoding process 800 shown in FIG. 8. Like elements are shown using the same reference signs, but incremented by ‘600’.

In this example, the first signal 1401 comprises a blank region 1426. The blank region 1426 may be considered to be an overlay region. In this example, the blank region 1426 of the first signal 1401 corresponds to the overlay region 1410 of the second signal 1408, at least in that they are in the same positions in the first and second signals 1401, 1408 respectively.

In this example, the residual generator 1417 calculates differences between (i) values of signal elements in the non-overlay region 1411 of the second signal 1408 and values of corresponding signal elements of the third signal 1416 and (ii) values of signal elements in the overlay region 1410 of the second signal 1408 and values of corresponding signal elements in the blank region 1426 of the first signal 1401. Since the values of signal elements in the blank region 1426 of the first signal 1401 are all zero, the residual generator 1417, in effect, replaces the (zero) values of signal elements in the blank region 1426 of the first signal 1401 with values of corresponding signal elements in the overlay region 1410 of the second signal 1408.

However, in this example, the first signal 1401 includes a blank region 1426. This may negatively impact viewing experience for viewers without the enhanced bitstream 1419. This may or may not be desirable.

The above-described examples provide a particularly effective application of LCEVC. They can enable a ticker, advert, or other content to be overlaid onto other video content. The overlay content can be encoded in a different manner from the main video. The residual part of LCEVC may be used to encode content in HDR. The main part of the video may be in SDR, such that only the overlay content is in HDR.

### Other Variations

Certain other variations of the examples described herein will now be described.

In some specific examples described above, the overlay region of the second signal comprises HDR overlay content, and the first signal comprises SDR content. In such examples, the residual data enables the HDR content to be communicated and used. Alternatively, encoder-decoder signalling may signal that given SDR content (for example the overlay content) is to be in HDR.

In some specific examples described above, a decoder is able to produce an output image having both SDR and HDR content. In such examples, the image may be displayed by a display device that can display both SDR and HDR content together. In other examples, the output image may comprise only SDR or only HDR content. This may be effective where the display device cannot display both SDR and HDR content together, but can display one or both of SDR and HDR content by itself.

### Example Apparatus for Implementing the Decoder or Encoder

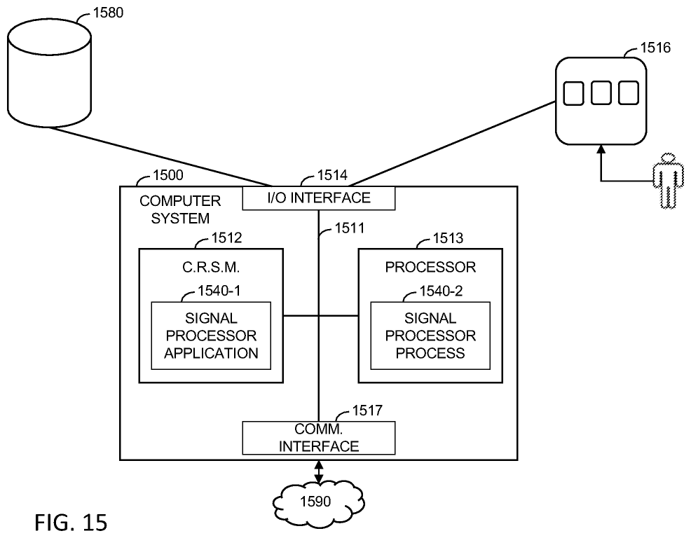

Referring to FIG. 15, there is shown a schematic block diagram of an example of an apparatus 1500.

Examples of the apparatus 1500 include, but are not limited to, a mobile computer, a personal computer system, a wireless device, base station, phone device, desktop computer, laptop, notebook, netbook computer, mainframe computer system, handheld computer, workstation, network computer, application server, storage device, a consumer electronics device such as a camera, camcorder, mobile device, video game console, handheld video game device, a peripheral device such as a switch, modem, router, a vehicle etc., or in general any type of computing or electronic device.

In this example, the apparatus 1500 comprises one or more processors 1501 configured to process information and/or instructions. The one or more processors 1501 may comprise a central processing unit (CPU). The one or more processors 1501 are coupled with a bus 1511. Operations performed by the one or more processors 1501 may be carried out by hardware and/or software. The one or more processors 1501 may comprise multiple co-located processors or multiple disparately located processors.

In this example, the apparatus 1501 comprises computer-useable memory 1512 configured to store information and/or instructions for the one or more processors 1501. The computer-useable memory 1512 is coupled with the bus 1511. The computer- usable memory may comprise one or more of volatile memory and non-volatile memory. The volatile memory may comprise random access memory (RAM). The non- volatile memory may comprise read-only memory (ROM).

In this example, the apparatus 1500 comprises one or more external data-storage units 1580 configured to store information and/or instructions. The one or more data-external storage units 1580 are coupled with the apparatus 1500 via an I/O interface 1514. The one or more external data-storage units 1580 may for example comprise a magnetic or optical disk and disk drive or a solid-state drive (SSD).

In this example, the apparatus 1500 further comprises one or more input/output (I/O) devices 1516 coupled via the I/O interface 1514. The apparatus 1500 also comprises at least one network interface 1590. Both the I/O interface 1514 and the network interface 1517 are coupled to the systems bus 1511. The at least one network interface 1517 may enable the apparatus 1500 to communicate via one or more data communications networks 1590. Examples of data communications networks include, but are not limited to, the Internet and a Local Area Network (LAN). The one or more I/O devices 1516 may enable a user to provide input to the apparatus 1500 via one or more input devices (not shown). The one or more I/O devices 1516 may enable information to be provided to a user via one or more output devices (not shown).

In FIG. 15, a (signal) processor application 1540-1 is shown loaded into the memory 1512. This may be executed as a (signal) processor process 1540-2 to implement the methods described herein (e.g. to implement suitable encoders or decoders). The apparatus 1500 may also comprise additional features that are not shown for clarity, including an operating system and additional data processing modules. The (signal) processor process 1540-2 may be implemented by way of computer program code stored in memory locations within the computer-usable non-volatile memory, computer-readable storage media within the one or more data-storage units and/or other tangible computer-readable storage media. Examples of tangible computer-readable storage media include, but are not limited to, an optical medium (e.g., CD-ROM, DVD-ROM or Blu-ray), flash memory card, floppy or hard disk or any other medium capable of storing computer-readable instructions such as firmware or microcode in at least one ROM or RAM or Programmable ROM (PROM) chips or as an Application Specific Integrated Circuit (ASIC).

The apparatus 1500 may therefore comprise a data processing module which can be executed by the one or more processors 1501. The data processing module can be configured to include instructions to implement at least some of the operations described herein. During operation, the one or more processors 1501 launch, run, execute, interpret or otherwise perform the instructions.

Although at least some aspects of the examples described herein with reference to the drawings comprise computer processes performed in processing systems or processors, examples described herein also extend to computer programs, for example computer programs on or in a carrier, adapted for putting the examples into practice. The carrier may be any entity or device capable of carrying the program. It will be appreciated that the apparatus 1500 may comprise more, fewer and/or different components from those depicted in FIG. 15. The apparatus 1500 may be located in a single location or may be distributed in multiple locations. Such locations may be local or remote.

The techniques described herein may be implemented in software or hardware, or may be implemented using a combination of software and hardware. They may include configuring an apparatus to carry out and/or support any or all of techniques described herein.

Various measures are described herein in which an overlaid video signal is encoded. The overlaid video signal comprises an HDR video signal overlaid onto a portion (e.g., less than 50%) of an SDR video signal. Various actions are performed for each image of the SDR video signal (and, in examples, for the HDR video signal). A decoded rendition of an encoded version of said image of the SDR video signal is received. An image of the HDR video signal is received. The image of the HDR video signal corresponds in time to said decoded rendition (of the encoded version of said image of the SDR video signal). The image of the HDR video signal is to be overlaid on the image of the SDR video signal. Residuals are determined by computing a difference between: (i) the decoded rendition (of the encoded version of said image of the SDR video signal), and (ii) a rendition of said image of the HDR video signal overlaid onto a portion of said image of the SDR image. The residuals are encoded to generate an enhancement layer. The enhancement layer is output.

The enhancement layer is configured to be processed, by a decoder, in combination with the encoded version of the image of the SDR video signal such that the decoder generates an overlaid image. The overlaid image comprises the image of the HDR video signal overlaid onto a portion of the image of the SDR video signal.

The overlaid video signal comprises said overlaid image and a plurality of further overlaid images derived from further images of the SDR video signal and further images of the HDR video signal.

This advantageously provides for efficient encoding (owing to the way LCEVC handles residuals efficiently) that corrects for defects of the base layer encoder whilst also enabling the SDR video to have an HDR overlay.

Known methods cannot solve both of these problems with a single method (or provide both of these advantages in a single solution).

The image of the SDR video signal may comprise an SDR image overlaid with an SDR rendition of the image of the HDR video signal.

The image of the HDR video signal may be received as a combined image. The combined image may comprise the image of the HDR video signal overlaid onto a version of the image of the SDR video signal.

The rendition of said image of the HDR video signal overlaid onto the portion of said image of the SDR image may be generated by overlaying the image of the HDR video signal onto the decoded rendition (of the encoded version of said image of the SDR video signal).

The above embodiments are to be understood as illustrative examples. Further embodiments are envisaged.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1-25. (canceled)

26. A method of signal processing, the method comprising:
processing a first signal by at least sending the first signal to an encoder to generate an encoded signal;
obtaining a second signal, the second signal comprising an overlay region, the overlay region of the second signal comprising overlay content;
processing at least the second signal to generate residual data; and
encoding the residual data to generate encoded residual data; and
outputting at least the encoded residual data.

27. The method according to claim 26, wherein the processing of at least the second signal to generate the residual data comprises processing the second signal and a third signal to generate the residual data.

28. The method according to claim 27, comprising receiving a decoded version of the encoded signal, wherein the third signal is based on the decoded version of the encoded signal.

29. The method according to claim 28, comprising up-sampling the decoded version of the encoded signal to generate an up-sampled signal, wherein the third signal comprises the up-sampled signal.

30. The method according to claim 27, wherein the processing of the second signal and the third signal to generate the residual data comprises:
calculating differences between values of signal elements in at least the overlay region of the second signal and values of corresponding signal elements in the third signal.

31. The method according to claim 30, wherein the corresponding signal elements in the third signal are comprised in an overlay region of the third signal.

32. The method according to claim 30, wherein the corresponding signal elements in the third signal are comprised in a non-overlay region of the third signal.

33. The method according to claim 30, wherein the processing of the second signal and the third signal to generate the residual data comprises:
combining values of signal elements in at least the overlay region of the second signal and values of corresponding signal elements in the third signal to generate a combined signal; and
calculating differences between values of signal elements in at least an overlay region of the combined signal and values of corresponding signal elements in the third signal,
wherein the overlay region of the combined signal corresponds to the overlay region of the second signal.

34. The method according to claim 33, wherein the second signal comprises a nonoverlay region, and wherein the non-overlay region of the second signal is a blank region.

35. The method according to claim 27, wherein the third signal comprises a reference signal, wherein the reference signal is independent of the first signal, and wherein the reference signal is a blank signal.

36. The method according to claim 35, wherein the residual data comprises substitutive residual data, the substitutive residual data comprising signal element values to be substituted in place of corresponding signal element values in another signal.

37. The method according to claim 26, wherein the first signal comprises content having a first dynamic range, wherein the second signal comprises content having a second dynamic range, and wherein the second dynamic range is higher than the first dynamic range.

38. The method according to claim 26, wherein:
the overlay content comprises or consists of high dynamic range (HDR) content; and/or
the first signal comprises or consists of standard dynamic range (SDR) content.

39. The method according to claim 26, wherein the first signal does not comprise said overlay content.

40. The method according to claim 26, wherein a first codec is used to generate the encoded signal and a second, different codec is used to generate the encoded residual data,
wherein the first codec is unable to encode the overlay region of the second signal.

41. The method according to claim 26, wherein the second signal has a given level of quality and wherein the given level of quality of the second signal is maintained during the processing of the second signal.

42. The method according to claim 26, comprising generating the second signal by applying an overlay signal to an input signal, the overlay signal comprising the overlay region.

43. The method according to claim 26, comprising:
obtaining a further signal, the further signal comprising a further overlay region, and the further overlay region comprising further overlay content, the further overlay content being different from the overlay content comprised in the overlay region of the second signal;
processing at least the further signal to generate further residual data; encoding the further residual data to generate further encoded residual data; and outputting the further encoded residual data,
wherein the further encoded residual data is output in association with the encoded signal or is output with the encoded residual data, and
wherein the residual data is indicative of the overlay content of the overlay region of the second signal.

44. A method of signal processing, the method comprising:
processing an encoded signal to generate a first signal;
processing encoded residual data by at least decoding the encoded residual data to generate decoded residual data; and
processing at least the first signal and the decoded residual data to generate a second signal, wherein the second signal comprises an overlay region comprising overlay content.

45. An apparatus comprising:
a processor;
a non-transitory computer storage device having stored thereon computer executable instructions that, when executed by the processor, cause the apparatus to perform the following:
process a first signal by at least sending the first signal to an encoder to generate an encoded signal;
obtain a second signal, the second signal comprising an overlay region, the overlay region of the second signal comprising overlay content;
process at least the second signal to generate residual data; and
encode the residual data to generate encoded residual data; and
output at least the encoded residual data.
